(19) United States
(12) Patent Application Publication
(10) Pub. No.: US 2019/0291085 A1
(43) Pub. Date: Sep. 26, 2019

(54) BULK METALLIC CATALYSTS AND METHODS OF MAKING AND USING THE SAME

(71) Applicant: ExxonMobil Research and Engineering Company, Annandale, NJ (US)

(72) Inventors: Chuansheng Bai, Phillipsburg, NJ (US); Majosefina Cunningham, Whitehall, PA (US); Gregory R. Johnson, Bound Brook, NJ (US)

(21) Appl. No.: 16/356,125

(22) Filed: Mar. 18, 2019

Related U.S. Application Data
(60) Provisional application No. 62/646,426, filed on Mar. 22, 2018.

(51) Int. Cl. B01J 27/051; B01J 27/049; B01J 21/18; B01J 21/08; B01J 21/06; B01J 35/10; B01J 37/04; B01J 37/08; B01J 37/20; C10G 45/08

(52) U.S. Cl. CPC B01J 27/0515; C10G 2300/301; B01J 21/18; B01J 21/08; B01J 21/06; B01J 35/1014; B01J 37/04; B01J 37/086; B01J 37/084; B01J 37/20; C10G 45/08; C10G 2300/1055; C10G 2300/70; C10G 2300/202; C10G 2400/04; B01J 27/049

(57) ABSTRACT

Bulk metallic catalyst precursors are provided that include a Group VIB metal, such as Ni, a Group VIII metal, such as Mo or W, an organic-compound based component, and an organo-metalloxane polymer or gel. The catalyst precursors can further include a binder. Amorphous sulfided catalysts formed from the catalyst precursors are also provided. The catalyst precursor can have a surface area of about 50 m²/g or less.

### CROSS-REFERENCE TO RELATED APPLICATIONS

This application claims priority to U.S. Provisional Application Ser. No. 62/646,426 filed Mar. 22, 2018, which is herein incorporated by reference in its entirety.

### FIELD

This disclosure relates to bulk metallic catalysts and corresponding catalyst precursors including a combination a Group VIII metal and Group VIB metal, such as Ni and Mo, at least one organic compound-based component, and an organo-metalloxane polymer and/or gel as well as methods of making and using the same, particularly in hydroprocessing methods.

### BACKGROUND

Regulations are placing more restrictive quality demands on diesel fuels. For example, the continuing reduction of sulfur specifications in diesel fuels has placed a strain on low pressure hydrotreating units. High pressure units can require increased amounts of hydrogen to perform hydrotreatment, and attempting to retrofit a low pressure unit to handle high pressure hydroprocessing can be expensive. Currently, undercutting and high start-of-run temperatures are used to produce ultra-low-sulfur diesel in low pressure hydrotreating units, but with the corresponding difficulties of undesirable liquid yield losses and/or reduced catalyst cycle length. Higher activity hydrodesulfurization catalysts could allow an increased number of existing low pressure hydrotreatment units to still be used while achieving desired sulfur target levels, thus reducing capital investment and/or avoiding increasing burdens on the hydrogen supply in a refinery.

U.S. Pat. Nos. 7,951,746; 9,174,206; and 9,731,283 describe catalysts developed in an attempt to provide increased activity for ultra-low sulfur processing of distillate and/or higher boiling range feeds.

### SUMMARY

In one aspect, a bulk metallic catalyst precursor is provided. The bulk metallic catalyst precursor includes Ni and either Mo or W. A combined amount of Ni and Mo or a combined amount of Ni or W may be about 30 wt % to about 85 wt % on a metal oxide basis. The metallic catalyst precursor further includes about 10 wt % to about 60 wt % of an organic compound-based component and about 1 wt % to about 50 wt % of an organo-metalloxane polymer, an organo-metalloxane gel, or a combination thereof. The organic compound-based component may be based on at least one organic complexing agent. The organo-metalloxane polymer may be selected from the group consisting of an organo-siloxane polymer, an organo-alumoxane polymer, an organo-titanoxane polymer, and a combination thereof.

In another aspect, an amorphous sulfided bulk metallic catalyst is provided. The amorphous sulfided bulk metallic catalyst includes Ni and either Mo or W. A combined amount of Ni and Mo or a combined amount of Ni or W may be about 30 wt % to about 85 wt % on a metal oxide basis. The amorphous sulfided bulk metallic catalyst further includes sulfides of one or more of: Ni, Mo, W, NiMo and NiW. The amorphous sulfided bulk metallic catalyst further includes about 10 wt % to about 60 wt % of an organic compound-based component and about 1 wt % to about 50 wt % of an organo-metalloxane polymer, an organo-metalloxane gel, or a combination thereof. The organic compound-based component may be based on at least one organic complexing agent. The organo-metalloxane polymer may be selected from the group consisting of an organo-siloxane polymer, an organo-alumoxane polymer, an organo-titanoxane polymer, and a combination thereof.

In another aspect, a method of preparing a bulk metallic catalyst precursor is provided. The method includes mixing a first aqueous solution with a second solution to form an intermediate solution, and drying and calcining the intermediate solution to form the bulk metallic catalyst precursor. The first aqueous solution includes (i) a Ni-containing precursor and a Mo-containing precursor, or a Ni-containing precursor and a W-containing precursor, and (ii) at least one organic complexing agent. The molar ratio, as a fractional value, of Mo to Ni or W to Ni may be about 0.1 to about 10, and the molar ratio, as a fractional value, of organic complexing agent to Ni and Mo or organic complexing agent to Ni and W may be about 0.1 to about 10. The second solution comprises at least one organo-metalloxane polymer, an organo-metalloxane gel, or a combination thereof, wherein the organo-metalloxane polymer is selected from the group consisting of an organo-siloxane polymer, an organo-alumoxane polymer, an organo-titanoxane polymer, and a combination thereof.

In another aspect, a method for hydroprocessing a diesel boiling range feed is provided. The method includes contacting the diesel boiling range feed with a bulk metallic catalyst in the presence of a treat gas comprising hydrogen (H₂) in at least one reaction zone under sufficient reaction conditions to produce a treated diesel product. The diesel boiling range feed includes a sulfur content of about 1 wt % to about 3 wt % and/or a nitrogen content of about 300 ppmw to about 1500 ppmw. The bulk metallic catalyst includes Ni and either Mo or W. A combined amount of Ni and Mo or a combined amount of Ni or W may be about 30 wt % to about 85 wt % on a metal oxide basis. The bulk metallic catalyst further includes sulfides of one or more of: Ni, Mo, W, NiMo and NiW. The bulk metallic catalyst further includes about 10 wt % to about 60 wt % of an organic compound-based component and about 1 wt % to about 50 wt % of an organo-metalloxane polymer, an organo-metalloxane gel, or a combination thereof. The organic compound-based component may be based on at least one organic complexing agent. The organo-metalloxane polymer may be selected from the group consisting of an organo-siloxane polymer, an organo-alumoxane polymer, an organo-titanoxane polymer, and a combination thereof.

In another aspect, a method for hydroprocessing a diesel boiling range feed is provided. The method includes contacting the diesel boiling range feed with a bulk metallic catalyst in the presence of a treat gas comprising hydrogen (H₂) in at least one reaction zone under sufficient reaction conditions to produce a treated diesel product. The diesel boiling range feed includes a sulfur content of about 1 wt % to about 3 wt % and/or a nitrogen content of about 300 ppmw to about 1500 ppmw. The bulk metallic catalyst includes a Group VIII metal and a Group VIB metal. A combined amount of Group VIII metal and a Group VIB metal may be about 30 wt % to about 85 wt % on a metal oxide basis. The bulk metallic catalyst further includes sulfides of one or more of Group VIII metal and Group VIB metal. The bulk metallic catalyst further includes about 10 wt % to about 60 wt % of an organic compound-based component and about 1 wt % to about 50 wt % of an organo-metalloxane polymer, an organo-metalloxane gel, or a combination thereof. The organic compound-based component may be based on at least one organic complexing agent. The organo-metalloxane polymer may be selected from the group consisting of an organo-siloxane polymer, an organo-alumoxane polymer, an organo-titanoxane polymer, and a combination thereof.

### BRIEF DESCRIPTION OF THE FIGURES

FIG. 1 provides X-ray diffraction (XRD) spectrums for Catalyst Precursor A and Catalyst Precursor B.

FIG. 2 provides an XRD spectrum for Catalyst Precursor C.

FIG. 3 provides an XRD spectrum for Catalyst Precursor D.

FIG. 4 shows hydrodesulfurization (HDS) activities for Catalyst B relative to a catalyst Reference 2 (dashed horizontal line) at various pressures for an LGO feed and a CHD-LCO blend feed.

FIG. 5 shows hydrodenitrogenation (HDN) activities for Catalyst B relative to a catalyst Reference 2 (dashed horizontal line) at various pressures for an LGO feed and a CHD-LCO blend feed.

FIG. 6 shows HDS activities for Catalyst A relative to a catalyst Reference 1 (dashed horizontal line) at various pressures for an LGO feed and a CHD-LCO blend feed.

FIG. 7 shows HDN activities for Catalyst A relative to a catalyst Reference 1 at 520 psi H₂ partial pressure for a CHD-LCO blend feed.

### DETAILED DESCRIPTION OF THE EMBODIMENTS

### Overview

The catalysts described herein can be bulk metallic catalyst precursors (also referred to herein as “bulk catalyst(s)”) and bulk metallic catalyst precursors (also referred to herein as “bulk catalyst precursors(s)”) including a Group VIII metal and a Group VIB metal, and optionally including an additional Group VIII metal. As used herein, “bulk metallic catalyst” may be used interchangeably with “unsupported catalyst,” meaning that the catalyst composition is not of the conventional catalyst form which has a preformed, shaped catalyst support which is then loaded with metals via impregnation or deposition catalyst. In any embodiment, the Group VIII metal can be a non-noble metal such as Co or Ni, the Group VIB metal can be Mo or W, or any combination thereof of one or more Group VIII and Group VIB metals. For example, the Group VIII metal can be Ni or Co, and the Group VIB metal can be Mo or W. Optionally, the bulk metallic catalyst precursor can be sulfided, for example, using a gas-phase sulfidation procedure at a suitable temperature, e.g., about 350° C. or less.

In addition to the metals, the bulk metallic catalyst precursor can further include an organic compound-based component and an organo-metalloxane polymer or gel, such as a water soluble organo-siloxane polymer. The organic-based component can be derived from or based on an organic complexing agent component used in the preparation of the bulk metallic catalyst precursor. Examples of the organic complexing agent are described in detail below. During bulk metallic catalyst precursor formation, the organic complexing agent can allow an amorphous catalyst structure (or at least amorphous within the detection limit of X-ray diffraction) to form. Without being bound by any particular theory, it is believed that the organo-metalloxane polymer and/or gel in the bulk metallic catalyst precursor can become at least partially associated with the amorphous structure provided by the organic complexing agent. This can allow the organo-metalloxane polymer and/or gel to provide additional stability for the amorphous structure, so that if any degradation of the organic compound occurs, the organo-metalloxane polymer and/or gel can allow the catalyst to substantially retain its structural integrity.

Based on X-ray diffraction, it appears that the Group VIII metals and the Group VIB metals in the bulk metallic catalyst precursor after heating do not have the long range ordering typically found in materials that are primarily a crystalline oxide. Instead, in some aspects it appears that the metals are complexed by the organic complexing agent in the bulk metallic catalyst precursor. The metals are complexed by the organic complexing agent when the metals and complexing agent are mixed together. The nature of the complex may change after one or more heating steps, as the organic complexing agent may undergo one or more conversions or reactions to form an organic compound-based component. In an alternative embodiment, the catalyst precursor can have some crystalline or nanocrystalline characteristics (based on XRD) in addition to having characteristics of metals that are complexed by the organic complexing agent.

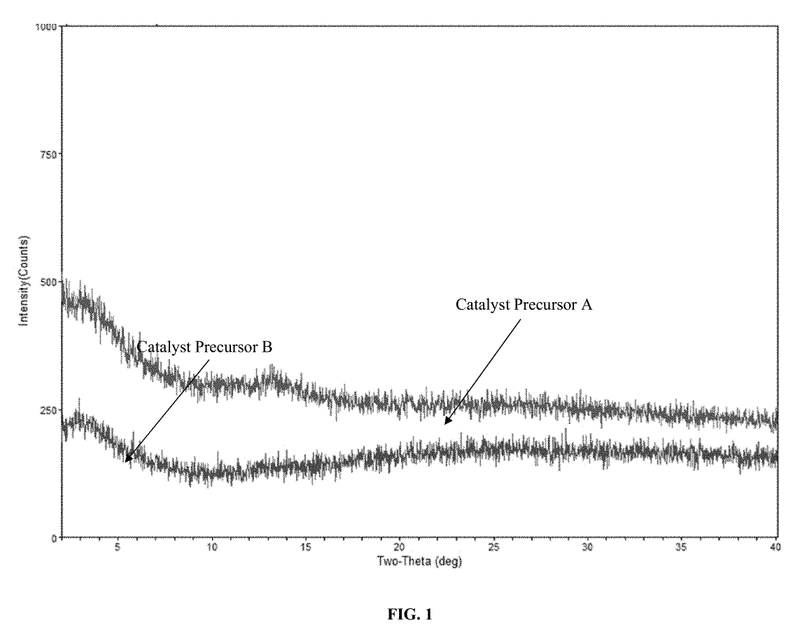

The X-ray diffraction data provided in FIGS. 1-3 herein were generated under the following conditions. X-ray powder diffraction analyses of the samples were obtained using a PANalytical™ X-pert PRO MPD, manufactured by PANalytical, Inc., and equipped with a X-Cellerator™ detector. The 2 theta scan used a Cu target at 45 kV and 40 mA. The diffraction patterns were taken in the range of 20° to 700 and 20° to 70° 2θ. The step size was 0.2 degrees and the time/step was 480 seconds. The remaining X-ray Diffraction data and patterns provided in this application were generated under the following conditions. X-ray powder diffraction analyses of the samples were obtained using a Bruker D4 Endeavor™, manufactured by Bruker AXS and equipped with a Vantec-1™ high-speed detector. The 2θ scan used a Cu target at 35 kV and 45 mA. The diffraction patterns were taken in the range of 2° to 70° 2θ. The step size was 0.01794 degrees and the time/step was 0.1 second.

In this application, an “amorphous” catalyst or catalyst precursor refers to a catalyst or catalyst precursor that lacks the long range order or periodicity to have peaks in X-ray diffraction spectra that can be sufficiently distinguished from the background noise in the spectra, such as by determining a ratio of peak intensity versus background noise. This definition for amorphous includes the possible presence of nanocrystalline portions of catalyst or catalyst precursor, since such nanocrystallinity cannot be resolved by XRD. Nanocrystalline catalyst or catalyst precursor refers to catalyst or catalyst precursor that has some crystallinity but with a grain size of less than 100 nm. This determination is made using X-ray diffraction spectra generated according to the conditions described above. Broadening of X-ray spectra occurs increasingly as particle sizes shrink, such as when grain sizes are <100 nm, resulting in an XRD pattern with broadened or apparently non-existent peaks. Without being bound by any particular theory, it is believed that the high activity of the catalyst systems according to various embodiments of the invention results from an amorphous and/or nanocrystalline component.

In any embodiment, the bulk catalyst particles according to the invention, formed by sulfidation of catalyst precursor particles, can have a characteristic X-ray diffraction pattern of an amorphous material. Generally, it is believed that the long range ordering typically found in crystalline phases of Group VIII and Group VIB metal oxides and/or sulfides are not present in the bulk metallic catalysts formed as described herein. In particular, XRD spectra of catalysts and catalyst precursors according to the invention either do not show crystalline phases of CoMo oxides, NiMo oxides, NiW oxides, or CoNiMo oxides, or alternatively only weakly show the crystalline CoMo, NiMo, NiW, or CoNiMo oxide character. Without being bound by any particular theory, it is believed that the organic complexing agent and/or the resulting organic compound-based component interrupts or inhibits crystallization of oxides of the Group VIII and Group VIB metals. Instead of forming crystalline oxides with long range ordering, it is believed that at least a portion of the bulk catalyst particles have a structure that continues to involve some sort of complex with an organic compound-based component. This structure may be amorphous and/or crystalline on a length scale that is not readily resolved by XRD. The nature of the complexation may differ from the complexation present in the catalyst precursor. Additionally, at least a portion of the metals present in the catalyst can be in the form of metal sulfides, as opposed to complexed metals or amorphous/small crystal metal oxides.

In this discussion, the terms “bulk catalyst” and “bulk catalyst precursor” are both used. During formation of a bulk catalyst, a Group VIII metal precursor, a Group VIB metal precursor, an organic complexing agent, and optionally an organo-metalloxane polymer and/or gel may be mixed together. After drying and/or calcining, the organo-metalloxane polymer and/or gel can become associated with an organic compound-based component (derived from the organic complexing agent) along with the metals. At this stage, the composition corresponds to/is defined as a “bulk catalyst precursor” for purposes of the claims below. Prior to use for hydroprocessing, the bulk catalyst precursor can be sulfided, which converts the metals to metal sulfides. After sulfidation, the composition corresponds to/is defined as a “bulk metallic catalyst” (also referred to herein as “bulk catalyst(s))” or “sulfided bulk metallic catalyst” (also referred to herein as “sulfided bulk catalyst(s)”) for purposes of the claims below.

### Bulk Metallic Precursors and Methods of Making the Same

Bulk Catalysts and Bulk Catalyst Precursors

In contrast to many conventional hydroprocessing catalysts, which typically are comprised of a carrier or support impregnated with at least one Group VIII metal and at least one Group VIB metal, the catalysts provided herein are bulk metallic catalysts. The bulk catalyst and/or corresponding bulk catalyst precursor may comprise a Group VIII metal and Group VIB metal. Examples of Group VIII metals are non-noble metals, such as Co and Ni, with Ni being preferred in some aspects. Examples of Group VIB metals are non-noble metals, such as but not limited to, Mo and W. In any embodiment, the bulk catalyst precursor may comprise Ni and Mo, Ni and W, Co and Mo, or Co and W. In any embodiment, the bulk catalyst and/or corresponding bulk catalyst precursor may comprise a combined amount of Group VIII metal (e.g. Ni) and Group VIB metal (e.g., Mo or W), based on metal oxide basis, of at least about 10 wt %, at least about 30 wt %, at least about 50 wt %, at least about 70 wt %, at least about 85 wt %, or about 90 wt %; or in range from about 10 wt % to about 90 wt %, about 30 wt % to about 85 wt % or about 50 wt % to about 85 wt %.

Optionally, the bulk catalyst and/or corresponding bulk catalyst precursor may further comprise an additional Group VIII metal. For example, the bulk catalyst precursor can comprise Ni, Mo, and Co; alternatively, the bulk catalyst precursor can comprise Ni, W, and Co. In any embodiment, the bulk catalyst and/or corresponding bulk catalyst precursor may comprise a combined amount of Group VIII metal (e.g. Ni), Group VIB metal (e.g., Mo or W), and additional Group VIII metal (e.g., Co) based on metal oxide basis, of at least about 10 wt %, at least about 30 wt %, at least about 50 wt %, at least about 70 wt %, at least about 85 wt %, or about 90 wt %; or in range from about 10 wt % to about 90 wt %, about 30 wt % to about 85 wt % or about 50 wt % to about 85 wt %.

The bulk catalyst and/or corresponding bulk catalyst precursor may have a relatively low surface area (measured by Brunauer-Emett-Teller method, or BET). For example, the bulk catalyst and/or corresponding bulk catalyst precursor may have a surface area (as measured by BET) of about 50 m²/g or less, about 40 m²/g or less, about 30 m²/g or less, about 20 m²/g or less, about 10 m²/g or less, about 5 m²/g or less, about 2.5 m²/g or less, about 1 m²/g or less. In any embodiment, the bulk catalyst and/or corresponding bulk catalyst may have surface area (as measured by BET) of at least about 0.05 m²/g, at least about 0.1 m²/g, or at least about 0.25 m²/g. Each of the above upper limits for the bulk catalyst precursor surface area is explicitly contemplated in conjunction with each of the above lower limits.

The bulk catalyst and/or corresponding bulk catalyst precursor may further include an organic compound-based component, which may be based on or derived from at least one organic complexing agent (further described below) used in the preparation of the bulk catalyst and/or corresponding bulk catalyst precursor. In any embodiment, the bulk catalyst and/or corresponding bulk catalyst precursor may comprise the organic compound-based component in an amount, based on weight of the bulk catalyst and/or corresponding bulk catalyst precursor, of at least about 5 wt %, at least about 10 wt %, at least about 20 wt %, at least about 30 wt %, at least about 40 wt %, at least about 50 wt % at least about 60 wt % or about 80 wt %; or in a range from about 5 wt % to about 80 wt %, about 10 wt % to about 60 wt % or about 20 wt % to about 50 wt %.

The bulk catalyst and/or corresponding bulk catalyst precursor may further include an organo-metalloxane polymer, organo-metalloxane gel, or a combination thereof (sometimes referred to herein as an “organo-metalloxane compound” or “organo-metalloxane polymer and/or gel”). The organo-metalloxane compound can be incorporated into a bulk catalyst precursor in order to improve the stability of the resulting bulk catalyst formed from the bulk catalyst precursor. The organo-metalloxane compound may be water soluble or not water soluble, for example, soluble in an organic solvent. In any embodiment, the organo-metalloxane compound may be present in the bulk catalyst and/or corresponding bulk catalyst precursor in an amount, based on weight of the bulk catalyst and/or corresponding bulk catalyst precursor, of at least about 0.5 wt %, at least about 5 wt %, at least about 10 wt %, at least about 20 wt %, at least about 30 wt %, at least about 40 wt %, or about 50 wt %.

In further various aspects, the amount of organo-metalloxane compound can be about 0.5 wt % to about 5.0 wt %, or about 0.5 wt % to about 10 wt %, or about 0.5 wt % to about 15 wt %, or about 0.5 wt % to about 20 wt %, or about 0.5 wt % to about 30 wt %, or about 0.5 wt % to about 50 wt %, or about 1 wt % to about 5.0 wt %, or about 1 wt % to about 10 wt %, or about 1 wt % to about 15 wt %, or about 1 wt % to about 20 wt %, or about 1 wt % to about 30 wt %, or about 1 wt % to about 50 wt %, or about 2 wt % to about 5 wt %, or about 2 wt % to about 10 wt %, or about 2 wt % to about 15 wt %, or about 2 wt % to about 20 wt %, or about 2 wt % to about 30 wt %, or about 2 wt % to about 50 wt %, or about 5 wt % to about 10 wt %, or about 5 wt % to about 15 wt %, or about 5 wt % to about 20 wt %, or about 5 wt % to about 30 wt %, or about 5 wt % to about 50 wt %, or about 10 wt % to about 15 wt %, or about 10 wt % to about 20 wt %, or about 10 wt % to about 30 wt %, or about 10 wt % to about 50 wt %.

An example of an organo-metalloxane polymer is an organo-siloxane polymer. Organo-siloxane polymers correspond to polymers with a backbone of alternating silicon and oxygen atoms (sometimes referred to as a silica backbone) that also have at least one type of organic functional group attached to at least a portion of the silicon atoms in the backbone. Examples of organo-siloxane polymers include polydimethylsiloxane and polyphenylsiloxane. More generally, organo-siloxane polymers can include polyalkylsiloxanes, polydialkylsiloxanes, polyarylsiloxanes, polydiarylsiloxanes, polyalkylarylsiloxanes, and co-polymers formed from the various types of organo-siloxane monomers. Various organo-siloxane polymers are commercially available. Examples of water soluble organo-siloxane polymers can include organo-siloxane polymers that include amine functional groups. Optionally, a portion of the monomers in an organo-siloxane polymer can correspond to siloxane monomers, silane monomers (i.e., monomers where an Si—Si bond continues the backbone of the polymer), and/or organosilane monomers. Due to the nature of the organo-siloxane polymer structure, many types of organo-siloxane polymers are water insoluble, which is defined herein as having a solubility in water of less than 1 gram per liter. However, some organo-siloxane polymers have additional functional groups as part of the organic portion that can result in water soluble polymers. For example, some Dynasylan® Hydrosil polymers available from Evonik have organic groups containing an amine functionality, so that the polymers are soluble in water.

Other examples of organo-metalloxane polymers and/or gels can include, but are not limited to, organo-alumoxane polymers and/or gels, organo-titanoxane polymers and/or gels, organo-zirconoxane polymers and/or gels, and organo-metalloxane polymers and/or gels based on La, Y, or a rare earth metal. It is noted that an organo-metalloxane can potentially include more than one type of metal with a metal-oxygen linkage. For example, organo-siloxanes and organo-alumoxanes can potentially include other metals with metal-oxygen linkages, such as rare earth metals or tin. Organo-alumoxanes are also commercially available. Additionally, organo-alumoxanes can be synthesized, such as according to the methods described U.S. Pat. No. 6,207,130, which is incorporated herein by reference for the limited purpose of incorporating a method for synthesis of organo-alumoxanes. In any embodiment, at least a portion of the organic functional groups of the organo-alumoxane polymer and/or gel may comprise carboxylates. Organo-titanoxanes are also known. An example of synthesis of an organo-titanoxane is provided in U.S. Pat. No. 2,870,181, which is incorporated herein by reference for the limited purpose of incorporating a method for synthesis of organo-titanoxanes. It is also believed that suitable organo-metalloxane polymers and/or gels can be formed, for example, from aqueous zirconium complexes. It is also believed that suitable organo-metalloxane polymers and/or gels can be formed, for example, from rare earth metal triflates.

In various aspects, the bulk catalyst and/or corresponding bulk catalyst precursor may comprise a carbon (C) content (e.g., from an organic compound-based component) of at least about 1 wt %, at least about 5 wt %, at least about 10 wt %, at least about 15 wt %, at least about 20 wt %, at least about 25 wt %, at least about 30 wt %, or about 35 wt %; or in a range from about 1 wt % to about 35 wt %, about 5 wt % to about 30 wt %, or about 10 wt % to about 30 wt %. Additionally or alternatively, the bulk catalyst and/or corresponding bulk catalyst precursor may comprise a silicon (Si) content (e.g., from an organo-siloxane polymer and/or gel) of at least about 1 wt %, at least about 2.5 wt %, at least about 5 wt %, at least about 7.5 wt %, or about 10 wt %; or in a range from about 1 wt % to about 10 wt %, about 1 wt % to about 5 wt % or about 2.5 wt % to about 5 wt %. Additionally or alternatively, the bulk catalyst and/or corresponding bulk catalyst precursor may comprise a silica (SiO₂) content (e.g., from an organo-siloxane polymer and/or gel) of at least about 1 wt %, at least about 2 wt %, at least about 5 wt %, at least about 10 wt %, at least about 15 wt %, at least about 20 wt %, or about 30 wt %; in a range from about 1 wt % to about 30 wt %, about 2 wt % to about 30 wt %, about 2 wt % to about 20 wt %, or about 2 wt % to about 10 wt %.

In various aspects, the bulk catalyst and/or corresponding bulk catalyst precursor may also include a binder. For example, after forming catalyst precursor particles that initially include metals, an organic complexing agent, and a silica polymer, suitable binders may be mixed with the precursor composition and extruded to form particles. Examples of suitable binders include, but are not limited to, organo-siloxane polymers as described herein, organo-alumoxane polymers as described herein, organo-titanoxane polymers as described herein, a silica polymer, silica resin, hydrosol, polyethylene glycol, and combinations thereof. For aspects including a binder, the surface area of the particles of the bulk catalyst and/or corresponding bulk catalyst precursor may be higher, such as about 30 m²/g or less, or about 25 m²/g or less, or about 20 m²/g or less, or the surface area can be similar to the bulk catalyst and/or corresponding bulk catalyst precursor without binder, as described above.

In various aspects, the bulk catalyst and/or corresponding bulk catalyst precursor can also contain any additional component that is conventionally present in hydroprocessing catalysts. For example, the bulk catalyst composition and/or bulk catalyst precursor can also contain an acidic component, e.g. phosphorus or boron compounds, additional transition metals, rare earth metals, main group metals such as Si or Al, or mixtures thereof. Suitable additional transition metals are, e.g. rhenium, ruthenium, rhodium, iridium, chromium, vanadium, iron, platinum, palladium, cobalt, copper, manganese, nickel, molybdenum, zinc, niobium, tungsten, and combinations thereof. The molar ratio of additional transition metal(s) to combined Group VIII metal(s) and Group VIB metal(s) (e.g., Ni and Mo, Co and Mo, Ni and W) ranges generally from about 1 to 10 to about 10 to 1. Expressed as a fractional value, the molar ratio is generally from about 0.1 to about 10. For example, the ratio of additional transition metal(s) to combined Group VIII metal(s) and Group VIB metal(s) (e.g., Ni and Mo, Co and Mo, Ni and W) can be less than or equal to about 10, or less than or equal to about 5, or less than or equal to about 3, or less than or equal to about 2, or less than or equal to about 0.9, or less than or equal to about 0.6, or greater than or equal to about 0.1, or greater than or equal to about 0.2, or greater than or equal to about 0.33, or greater than or equal to about 0.5. All these metals may generally be present in the sulfided form if the catalyst composition has been sulfided. Prior to sulfidation, at least a portion of one or more metals can be complexed by the organic compound-based component in the bulk catalyst precursor. After sulfidation, it is believed that at least a portion of the sulfided metals are still somehow directly or indirectly bound to the organic compound-based component (e.g., carbon) in the catalyst.

Methods of Preparing the Bulk Catalyst Precursors and Bulk Catalysts

Bulk catalysts as described herein can be prepared by the controlled heating of Group VIII and Group VIB precursor compounds that are complexed with an organic complexing agent, such as an organic acid, and further supported by an organo-metalloxane polymer, such as a silica polymer, that is associated with the structure formed by the organic complexing agent. The organic complexing agent can be a metal binding group or chelating agent, a bidentate ligand, or a combination thereof. Preferably, the organic complexing agent is suitable for forming metal-ligand complexes in solution.

In any embodiment, where the bulk catalyst precursor is formed from a solution containing the Group VIII metal, Group VIB metal, organic complexing agent, and optionally an organo-metalloxane compound, the Group VIII compound and/or the Group VIB compound can be water soluble salts in the appropriate predetermined concentration to yield the desired molar ratios. In any embodiment, the Group VIII metals can be non-noble metals, such as Co and Ni, with Ni being preferred in some aspects. Preferably, the Group VIII metals are non-noble metals. Examples of Group VIB metals are Mo and W. Non-limiting examples of suitable Co-containing precursor compounds include carbonates, nitrates, sulfates, acetates, chlorides, hydroxides, propionates, glycinates, hydroxycarbonates, acetyl acetates, acetyl acetonates, metallic Co(O), Co oxides, Co hydrated oxides, Co carboxylates (in particular Co glyoxylate), Co citrate, Co gluconate, Co tartrate, Co glycine, Co lactate, Co naphthenate, Co oxalate, Co formate, and mixtures thereof, including ammonium or amine forms of the above. Non-limiting examples of suitable Ni-containing precursor compounds include carbonates, nitrates, sulfates, acetates, chlorides, hydroxides, propionates, glycinates, gluconates, and hydroxycarbonates. Preferred molybdenum-containing and tungsten-containing precursor compounds include alkali metal or ammonium molybdate (also peroxo-, di-, tri-, tetra-, hepta-, octa-, or tetradecamolybdate), molybdic acid, phosphomolybdic acid, phosphotungstic acid, Mo—P heteropolyanion compounds, W—Si heteropolyanion compounds, Co—Mo—W heteropolyanion compounds, alkali metal or ammonium tungstates (also meta-, para-, hexa-, or polytungstate), acetyl acetonates, and mixtures thereof. In still other embodiments, any suitable Group VIII or Group VIB metal precursors can be used to prepare Group VIII or Group VIB metal solutions.

In any embodiment, the organic acid complexing agent can be an organic acid. Non-limiting examples of organic complexing agents suitable for use herein include pyruvic acid, levulinic acid, 2-ketogulonic acid, keto-gluconic acid, thioglycolic acid, 4-acetylbutyric acid, 1,3-acetonedicarboxylic acid, 3-oxo propanoic acid, 4-oxo butanoic acid, 2,3-diformyl succinic acid, 5-oxo pentanoic acid, 4-oxo pentanoic acid, ethyl glyoxylate, glycolic acid, glyoxylic acid, glucose, glycine, oxamic acid, glyoxylic acid 2-oxime, ethylenediaminetetraacetic acid, nitrilotriacetic acid, N-methylaminodiacetic acid, iminodiacetic acid, diglycolic acid, malic acid, gluconic acid, acetylacetone, citric acid, and combinations thereof. Preferred organic acids are glyoxylic acid, oxalacetic acid, 2-ketogulonic acid, alpha-ketoglutaric acid, 2-ketobutyric acid, pyruvic acid, keto-gluconic acid, thioglycolic acid, glycolic acid, and combinations thereof. In any embodiment, the organic complexing agent can be glyoxylic acid, gluconic acid, oxalacetic acid, or a combination thereof.

In another aspect, the organic complexing agent can be an organic acid that contains a —COOH functional group and at least one additional functional group selected from carboxylic acid: —COOH, hydroximate acid: —NOH—C═O, hydroxo: —OH, keto —C═O, amine: —NH₂, amide: —C(═O)—NH₂, imine: —C═NOH, epoxy: =COC═, or thiol: —SH. In some aspects, the organic complexing agent can be a bidentate ligand.

The process for preparing the catalysts of the present invention can include multiple steps. The first step may be a mixing step wherein at least one Group VIII metal precursor, at least one Group VIB metal precursor, and at least one organic complexing agent are combined together. Optionally, the organo-metalloxane polymer and/or gel can also be incorporated into the catalyst precursor at this step. In any embodiment, one or more of the metal precursors and organic complexing agent can be provided in the form of solutions, such as aqueous solutions. In any embodiment, one or more of the metal precursors and organic complexing agent can be provided in the form of slurries. In still another embodiment, one or more of the metal precursors and organic complexing agent can be provided in the form of a solid material. Those of skill in the art will recognize that still other forms of providing the organic complexing agent and metal precursor(s) are possible, and that any suitable form (solution, slurry, solid, etc.) can be used for each individual precursor and/or organic complexing agent in a given synthesis.

The metal precursors and organic complexing agent (and optionally the organo-metalloxane polymer and/or gel) are mixed together to form an intermediate solution. In any embodiment where one or more of the metal precursors or organic complexing agent are provided as a solution or slurry, mixing can involve adding the metal precursors and organic complexing agent to a single vessel. If one or more of the metal precursors and organic complexing agent are provided as solids, mixing can include heating the organic complexing agent to a sufficient temperature to melt the complexing agent. This will allow the organic complexing agent to solvate any solid metal precursors.

The organo-metalloxane polymer and/or gel, can be incorporated into the bulk catalyst precursor in any convenient manner. In some aspects, the organo-metalloxane polymer and/or gel can be incorporated by impregnation. After formation of a bulk catalyst precursor, but prior to heating to modify the nature of the organic complexing agent, the bulk catalyst precursor can be impregnated with the organo-metalloxane polymer and/or gel. The impregnation can occur, for example, by dissolving the organo-metalloxane polymer and/or gel in a suitable solvent and then exposing the bulk catalyst precursor to the solution containing the organo-metalloxane polymer and/or gel. The bulk catalyst precursor can be exposed to the solution for an effective amount of time, such as about 1 minute to about 10 hours, to impregnate the catalyst precursor. For water soluble polymers or gels, the organo-metalloxane polymer/gel can be an aqueous solution. For polymers or gels that are not soluble in water, the polymer or gel can be dissolved in an organic solvent such as decane, cyclohexane, or another convenient solvent. Alternatively, polymers or gels that are not soluble in water can be dissolved in a solution containing water and a co-solvent or compatibility solvent. For example, alcohols containing at least 6 carbons, or at least 8 carbons, and optionally containing at least 3 carbons per oxygen, or at least 4 carbons per oxygen, or at least 5 carbons per oxygen, can serve as a co-solvent to allow a water insoluble polymer to be dissolved in a solution having a single phase where at least 25 wt % of the solvent is water, or at least 50 wt %, or at least 70 wt %.

Rather than impregnating a catalyst precursor after the catalyst precursor is formed, another option can be to include the organo-metalloxane polymer and/or gel in the synthesis mixture used to form the catalyst precursor. In this type of aspect, a solution of the organo-metalloxane polymer and/or gel can be added in a desired amount to the synthesis mixture. The synthesis mixture for forming a catalyst precursor as described herein can often correspond to an aqueous mixture, so an aqueous solution or a solution with co-solvents of water and a co-solvent (such as a long chain alcohol) can be used to introduce the organo-metalloxane polymer and/or gel into the synthesis mixture.

In any embodiment, the method may comprise mixing a first solution with a second solution to form an intermediate solution. The first solution may be an aqueous solution. The first solution may include one or more Group VIII metal precursors as described herein, such as a Ni-containing precursor, and one or more Group VIB metal precursor as described herein, such as a Mo-containing or a W-containing precursor. In any embodiment, the first solution may comprise at least three of: a Ni-containing precursor, a Mo-containing precursor, a W-containing precursor, and Co-containing precursor, for example, the first solution may include a Ni-containing precursor, a Co-containing precursor and a Mo-containing precursor. The molar ratio of Group VIII metal(s) to Group VIB metal(s) ranges generally from about 1 to 10 to about 10 to 1. Expressed as a fractional value, the molar ratio is generally from about 0.1 to about 10. For example, the ratio of Group VIII metal to Group VIB metal can be less than or equal to about 10, or less than or equal to about 5, or less than or equal to about 3, or less than or equal to about 2, or less than or equal to about 0.9, or less than or equal to about 0.6, or greater than or equal to about 0.1, or greater than or equal to about 0.2, or greater than or equal to about 0.33, or greater than or equal to about 0.5.

The first solution may also include an organic complexing agent as described above. For example, the organic complexing agent may be an organic acid as described herein, preferably, glyoxylic acid, gluconic acid, oxalecetic acid and a combination thereof, and more preferably, gluconic acid. The molar ratio of organic complexing agent to combined Group VIII metal(s) and Group VIB metal(s) ranges generally from about 1 to 10 to about 10 to 1. Additionally or alternately, the molar ratio used in the mixing solution (e.g., first aqueous solution) of organic complexing agent to combined Group VIII metal(s) and Group VIB metal(s) can be about 6.0 to 1 or less, or about 5.5 to 1 or less, or about 5.0 to 1 or less, or about 4.8 to 1 or less, or about 4.6 to 1 or less and/or about 0.5 to 1 or more, or about 1 to 1 or more, or is about 1.5 to 1 or more, or about 2 to 1 or more, or about 2.5 to 1 or more, or about 3.0 to 1 or more, or about 3.5 to 1 or more. Expressed as a fractional value, the molar ratio is generally from about 0.1 to about 10. For example, the ratio of organic complexing agent to combined Group VIII metal(s) and Group VIB metal(s) can be less than or equal to about 10, or less than or equal to about 5, or less than or equal to about 3, or less than about 2, and/or greater than or equal to about 0.1, or greater than or equal to about 0.33, or greater than or equal to about 0.5.

In any embodiment, the second solution may include at least one organo-metalloxane polymer and/or organo-metalloxane gel as described herein, which may be dissolved in water, an alcohol or an organic solvent. For example, the organo-metalloxane polymer may be selected from the group consisting of an organo-metalloxane siloxane polymer as described herein, an organo-alumoxane polymer as described herein, an organo-titanoxane polymer as described herein, and a combination thereof.

The temperature during mixing can be from ambient temperature to the boiling point of the solvent. The preparation can be performed in any suitable way. For example, in embodiments involving solutions and/or slurries, separate solutions (or slurries) can be prepared from each of the catalytic components. That is, a Group VIII metal compound in a suitable solvent and a Group VIB metal in a suitable solvent can be formed. Non-limiting examples of suitable solvents include water and the Ci to C₃ alcohols. Other suitable solvents can include polar solvents such as alcohols, ethers, and amines. Water is a preferred solvent. It is also preferred that the Group VIII metal precursor and the Group VIB precursor be water soluble and that a solution of each be formed, or a single solution containing both metals be formed. The organic complexing agent can be prepared in a suitable solvent, preferably water. The three solvent components can be mixed in any sequence. That is, all three can be blended together at the same time, or they can be sequentially mixed in any order. In any embodiment, it is preferred to first mix the two metal precursors in an aqueous media, than add the organic complexing agent to form the first aqueous solution. Optionally, the organo-metalloxane polymer and/or gel can also be added as a solution (e.g., the second solution), such as an aqueous solution or a solution based on water and a co-solvent, which may be mixed with the first aqueous solution In an optional aspect, the four solvent components can be mixed in any sequence.

The process conditions during the mixing step are generally not critical. It is, e.g., possible to add all components at ambient temperature at their natural pH (if a suspension or solution is utilized). It is generally preferred to keep the temperature below the boiling point of water, i.e., 100° C. to ensure easy handling of the components during the mixing step. However, if desired, temperatures above the boiling point of water or different pH values can be used. In any embodiment where the organic complexing agent is an acid or base having a conjugate base/acid, the pH of the mixture can be adjusted to drive the acid/base equilibrium toward a desired form. For example, if the organic complexing agent is an acid, the pH of the solution can be raised to drive the equilibrium toward formation of the conjugate base. If the reaction during the mixing step is carried out at increased temperatures, the suspensions and solutions that are added during the mixing step are preferably preheated to an increased temperature which can be substantially equal to the reaction temperature.

The amount of metal precursors and organic complexing agent (and optionally the organo-metalloxane polymer and/or gel) in the mixing step can be selected to achieve preferred ratios of metal to organic compound-based material in the catalyst precursor after heating. For example, the ratio of organic acid to total metal in the mixed solution (or other mixture of metal precursors and organic complexing agent) can reach a minimum level that results in a highly active catalyst.

In any aspect, the amount of organic complexing agent used in the mixed solution (e.g., the first aqueous solution) can be enough to provide at least about 10 wt % of organic compound-based component in the catalyst precursor formed after heating, or at least about 20 wt %, or at least about 25 wt %, or at least about 30 wt %. In another aspect, the amount of organic complexing agent used in the mixed solution (e.g., the first aqueous solution) can provide less than about 60 wt % of organic compound-based component in the catalyst precursor formed after heating, or less than about 40 wt %, or less than about 35 wt %, or less than about 30 wt %. For example, the amount of organic complexing agent used in the mixed solution (e.g., the first aqueous solution) can be enough to provide between about 20 wt % and about 35 wt % of organic compound-based component in the resulting catalyst precursor.

A desired amount of organic compound-based component in the catalyst precursor can be achieved based on the amount of organic complexing agent to metal ratio in the mixed solution (e.g., the first aqueous solution) and based on the thermal activation conditions used to form the catalyst precursor. The term “organic compound-based component” refers to the carbon containing compound present in either the catalyst precursor after heating, or in the catalyst after sulfidation. The organic compound-based component is derived from or based on the organic complexing agent, but may be modified due to heating of the catalyst precursor and/or sulfidation of the precursor to form the catalyst. Note that the eventual form of the organic compound-based component may include carbon not traditionally considered as “organic,” such as graphitic or amorphous carbon. The term organic compound-based component used here specifies only that the carbon was derived originally from the organic complexing agent and/or another organic carbon source used in forming the catalyst precursor.

In this discussion, the weight percentage of organic compound-based component in the catalyst precursor was determined by performing a Temperature Programmed Oxidation on the catalyst precursor under the following conditions. Temperature Programmed Oxidation using TGA/MS was performed on dried and heated samples. The TGA/MS data was collected on a Mettler TGA 851 thermal balance which was interfaced with a quadrupole mass spectrometer equipped with a secondary electron multiplier. Between 20 and 25 mg of sample was heated at 4° C./min from ambient temperature to 700° C. in flowing 14.3% O₂ in He (77 cc/min) at one atmosphere total pressure. In the TGA/MS experiments, the effluent gas was carried over to the MS instrument via a capillary line and specific m/e fragments such as 18 (H₂O), 44 (CO₂), 64 (SO₂) were analyzed as markers for the decomposition products and qualitative correlation with gravimetric/heat effects.

The weight percentage of material lost during a TPO procedure represents the weight percentage of organic compound-based component. The remaining material in the catalyst precursor is considered to be metal in the form of some type of oxide. For clarity, the weight percent of metal present in the catalyst precursor is expressed as metal oxide in the typical oxide stoichiometry. For example, weights for cobalt and molybdenum are calculated as CoO and MoO₃, respectively.

A similar calculation can be performed to determine the weight percentage of organic compound-based component in the catalyst formed after sulfidation. Once again, the weight percent of organic compound-based component is determined by TPO, according to the method described above. The remaining weight in the catalyst corresponds to metal in some form, such as oxide, oxysulfide, or sulfide.

The amount of organic complexing agent used in the mixed solution can also be enough to form metal-organic complexes in the solution under reaction conditions. In any embodiment where the complexing agent is an organic acid, the ratio of carboxylic acid groups of the organic acids to metals can be at least about 0.33, or at least about 0.5, or at least about 1 (meaning that about the same number of carboxylic acid groups and metal atoms are present), or at least about 2, or at least about 3. In another embodiment, the ratio of carboxylic acid groups to metals can be 12 or less, or 10 or less, or 8 or less.

A subsequent step in the process for preparing a bulk catalyst from a catalyst precursor, for example, after mixing a first solution with a second solution to form an intermediate solution as described above, is a heating and/or drying step. In various aspects, the heating and/or drying step can be used to remove water from the mixture (e.g., the intermediate solution) and/or to form an organic compound-based component in the catalyst precursor. The organic compound-based component is the product of heating the organic complexing agent used in the mixing solution. The organic complexing agent may be substantially similar to the organic compound-based component, or the organic compound-based component may represent some type of decomposition product of the organic complexing agent. Alternatively, without being bound by any particular theory, heating of the organic complexing agent may result in cross linking of the complexing agent to form an organic compound-based component.

In some aspects, the heating and/or drying can be performed in multiple phases according to a heating profile. For example, the first phase of the heating profile can be a partial drying phase, such as a drying phase performed at a temperature from about 40° C. to about 60° C. in a vacuum drying oven for an effective amount of time. An effective amount of time corresponds to a time sufficient to remove water to the point of gel formation. Typically it is believed a gel will form when from about 80% to about 90% of the water is removed. In embodiments where the mixture of the metal precursors and the organic complexing agent is in the form of a solution or slurry, it can be preferred to agitate the mixture of metal precursors, organic complexing agent, and optional organo-metalloxane polymers/compound(s) at about ambient temperature for an effective period of time to ensure substantial uniformity and dissolution of all components prior to heating. Alternatively, in embodiments where the organic complexing agent is provided as a solid, an initial heating phase can correspond to heating used to melt the organic complexing agent. The temperature of the mixture can be maintained for an effective amount of time to allow the melted organic complexing agent to solvate and/or mix with the metal precursors.

In any embodiment, the next heating or drying phase in the heating profile may be to raise the temperature to about 110° C. to about 130° C., preferably from about 110° C. to about 120° C., to drive off additional water to the point that high temperature heating can be done without causing boiling over and splashing of solution. At this point the gel will be transformed into a solidified material. The effective amount of time to form the dried material, that is from gel formation to solidified material, can be from seconds to hours, preferably from about 1 minute to several days, more preferably from about 1 minute to 24 hours, and still more preferably from about 5 minutes to about 10 hours. The gel, upon solidification and cooling to room temperature can also take the form of a black rubbery solid material. The gel or solidified material can be brought to ambient temperature and saved for future heating at higher temperatures. In the alternative, the gel or solidified material can be used as a catalyst precursor at this stage.

Optionally, the solid material can be ground to a powder before or after thermal activation. The grinding can take place prior to any heating steps at temperatures of about 275° C. or greater, or the grinding can take place after heating to about 275° C. or greater. Any suitable grinding technique can be used to grind the solid material. In aspects where the organo-metalloxane polymer and/or gel is not introduced as part of the mixing solution, it can be convenient to impregnate the powder with the organo-metalloxane polymer and/or gel.

The catalyst precursor can be subjected to a further heating stage and/or calcining stage to partially decompose materials within the catalyst precursor. This additional heating stage and/or calcining stag can be carried out at a temperature from about 100° C. to about 500° C., preferably from about 250° C. to about 450° C., more preferably from about 300° C. to about 400° C., and still more preferably from about 300° C. to about 340° C., for an effective amount of time. This effective amount of time can range from about 0.5 to about 24 hours, such as from about 1 to about 5 hours. In any embodiment, heating and/or calcining can be accomplished by ramping the temperature in a furnace from room temperature to about 400° C. in one hour. Optionally, the catalyst precursor can then be held at a temperature of about 400° C. for about 1 hour to 10 hours, about 1 hour to 5 hours or about 1 hour to 4 hours. In any embodiment, the heating, drying and/or calcining (including possible decomposition) can be carried out in the presence of a flowing oxygen-containing gas such as air, a flowing inert gas such as nitrogen, or a combination of oxygen-containing and inert gases. In another embodiment, the heating, drying, and/or calcining can be carried out in the atmosphere present in the furnace at the beginning of the heating process. This can be referred to as a static condition, where no additional gas supply is provided to the furnace during heating. The atmosphere in the furnace during the static condition can be an oxygen-containing gas or an inert gas. It is preferred to carry out the heating in the presence of an inert gas atmosphere, such as nitrogen. Without being bound by any particular theory, the material resulting from this additional heating may represent a partial decomposition product of the organic complexing agent, resulting in the metals being complexed by an organic compound-based material or component.

Without being bound by any particular theory, it is believed that the organic complexing agent and/or the resulting organic-compound based component plays a role in the unexpected high activity of the final catalysts. It is believed that the organic complexing agent and/or the resulting organic compound-based component either assists in stabilization of the metal particles and/or directly interacts with metal active sites and prevents the metal from agglomerating. In other words, the organic complexing agent and/or organic compound-based component enhances the dispersion of the active sites. When a catalyst precursor is formed with an amount of organic compound-based component that is less than the desired range, the activity of the resulting catalyst is lower.

Additionally or alternately, without being bound by any particular theory, it is believed that the organo-metalloxane polymer and/or gel can become associated with the organic material (such as the organic compound-based component) resulting from the additional heating of the catalyst precursor. This association can occur prior to heating (such as by association of the polymer with the organic complexing agent), during heating, or after heating. For example, the organic compound-based component can be based on functional groups from the organo-metalloxane polymer and/or gel. It is believed that the association of the organo-metalloxane polymer and/or gel with the material resulting from the additional heating can allow a secondary silica structure to form in the catalyst. This secondary silica structure can reduce or minimize the amount of loss in structural integrity that could occur when a portion of the organic complexing agent and/or the resulting decomposition product from heating is removed from the catalyst or catalyst precursor structure. For example, many of the types of hydrocarbon feeds that can be hydrotreated using the catalyst can also represent feeds that can act as solvents for the organic complexing agent and/or the organic compound-based component. During a hydrotreatment processing run, a portion of the organic material in a catalyst can be solvated and removed from the catalyst structure. Without the presence of the secondary silica structure, the removal of organic material can lead to a corresponding removal of catalytic Group VIII and/or Group VIB metals from the catalyst as well. The presence of the secondary silica structure in the catalyst can reduce or minimize such loss of catalytic metals when solvation or other removal of organic material from the catalyst occurs.

The association between the organic material in a bulk catalyst or bulk catalyst precursor and the organo-metalloxane polymer and/or gel can potentially be enhanced for water soluble polymers or gels. For example, water soluble organo-metalloxane polymers and/or gels can tend to have organic portions that include polar functional groups, such as amine groups. These polar functional groups can contribute to the solubility of the polymer. Without being bound by any particular theory, it is believed that such functional groups can also contribute to and/or enhance the association of the organo-metalloxane polymer and/or gel with the organic material in a bulk catalyst. This enhanced association can allow the secondary silica structure formed by the organo-metalloxane polymer and/or gel to have an improved ability to retain metals in the catalyst during hydroprocessing.

As previously mentioned, the heating step can be performed in a variety of ways. The heating step can start with one or more initial heating stages at a lower temperature followed by heating at a temperature of about 275° C. or greater. In other embodiments, the heating profile can include only temperatures of about 130° C. or lower, or the heating profile can include immediately ramping the temperature to about 275° C. or greater, or about 325° C. or greater. In some aspects, the preparation conditions can be controlled and designed so that the mixed solution does not go through violent evaporation, spill or interruption during the entire heating profile. Such embodiments typically involve an initial heating at a temperature below 100° C. In other aspects, the heating profile can include conditions that lead to rapid evaporation while the catalyst precursor still contains a substantial amount of water. This can lead to boiling or splashing of the mixture used to form the catalyst precursor. While boiling or splashing of the mixture for forming the catalyst precursor is inconvenient, it is believed that a suitable catalyst precursor can still be formed under these conditions.

A bulk powder catalyst precursor composition according to the invention, obtained after grinding and heating, can be directly formed into shapes suitable for a desired catalytic end use. Alternately, the bulk powder can be mixed with a conventional binder material then formed into the desired shapes. If a binder is used, it may be either introduced before or after decomposition (heating) of the mixture used to form the catalyst precursor. Examples of potential binders include Actigel™ clay, available from Active Minerals International of Hunt Valley, Md.; Nyacol™ 2034 DI, available from Nyacol Nano Technologies, Inc. of Ashland, Mass.; Dupont™ Tyzor® LA, which is a lactic acid chelated titanium binder; a polyethylene glycol polymer, such as one having suitable molecular weight and other properties to allow for mixing of bulk catalyst precursor powder with the polyethylene glycol and then extruding the bound catalyst; or a Si-resin, such as Q-2230™ available from Dow Corning. In still another embodiment, a binder precursor, such as silicic acid, Si acetate, or Al acetate, may be added to the mixture used for synthesizing the catalyst precursor.

An additional step in the preparation of the catalysts of the invention may include a sulfidation step. Sulfidation is generally carried out by contacting the bulk catalyst precursor with a sulfur containing compound, such as elemental sulfur, hydrogen sulfide or polysulfides. Sulfidation can also be carried out in the liquid phase utilizing a combination of a polysulfide, such as a dimethyl disulfide spiked hydrocarbon stream, and hydrogen. The sulfidation can be carried out subsequent to the preparation of the bulk catalyst composition but prior to the addition of a binder, if used. In any embodiment, sulfidation of the bulk catalyst precursor may form an amorphous sulfide bulk catalyst.

If the catalyst composition is used in a fixed bed process, sulfidation can be carried out subsequent to the shaping step. Sulfidation may be carried out ex situ or in situ. For ex situ sulfidation, sulfidation is carried out in a separate reactor prior to loading the sulfided catalyst into the hydroprocessing unit. In situ sulfidation is preferred and for in situ sulfidation the sulfidation is carried out in the same reactor used for hydroprocessing.

In any embodiment, the sulfidation can be a gas phase sulfidation process. Due to the nature of the catalyst precursor, liquid phase sulfidation methods can lead to a reduction in the mass and/or integrity of the catalyst. However, gas phase sulfidation methods have a tendency to increase the stack height of active material in a catalyst, which leads to a corresponding drop in activity. This loss in activity can be avoided by using a gas phase sulfidation method with a sulfidation temperature of 350° C. or less. This is in contrast to some conventional gas phase sulfidation methods, which are typically performed at 400° C.

In another embodiment, the sulfidation step can be a liquid sulfidation. In such an embodiment, the bulk catalyst precursor can be sulfided by exposing the catalyst to a feedstock spiked with 1.36% by weight of dimethyl disulfide. Alternatively, the spiking level of dimethyl disulfide can be between 0.5 and 2.5% by weight. The catalyst can be exposed to the feed at a pressure of 500 psig at a LHSV of 1.0 hr¹ and hydrogen flow rate of 700 scf/B. Preferably, the catalyst can be exposed to the feed for an initial period of time, such as 18 hours, at a temperature of 425° F. (218° C.), followed by a second period of time, such as 24 hours, at a temperature of 625° F. (329° C.). In other embodiments, other conventional methods of sulfidation can be used.

In any embodiment involving liquid sulfidation, the bulk catalyst precursor can be sulfided using temperature and pressure conditions that are more severe than the expected eventual processing conditions. For example, if the sulfided catalyst will be used for processing a feedstock at a pressure of 150 psig, the sulfidation can be performed at a higher pressure to reduce the time needed to achieve sulfidation of the catalyst.

In any embodiment, the sulfided bulk catalyst may include at least one organo-metalloxane polymer and/or organo-metalloxane gel as described herein, for example in an amount of about 1 wt % to about 50 wt %. For example, the organo-metalloxane polymer may be selected from the group consisting of an organo-metalloxane siloxane polymer as described herein, an organo-alumoxane polymer as described herein, an organo-titanoxane polymer as described herein, and a combination thereof. In any embodiment, the sulfided bulk catalyst formed after sulfidation is believed to have at least in part a structure involving complexation or another interaction of metals by/with an organic compound-based component. The nature of the organic compound-based component in the sulfided catalyst may or may not differ from the organic compound-based component in the catalyst precursor and the organic complexing agent used in the initial mixture to form the catalyst precursor. Note that in the Examples below, the carbon and sulfur species in the sulfided catalyst appear to oxidize and leave the catalyst at a similar time in Temperature Programmed Oxidation studies. One possible interpretation for these TPO studies is the presence of a complex (or some other type of interaction) between the organic compound-based component and metals in at least a portion of the catalyst structure. At least some of the association between the organic compound-based component and the organo-metalloxane (such as an organo-siloxane polymer) is believed to remain after sulfidation. The carbon content of the catalyst after sulfidation can be about 10 wt % to about 25 wt %, or about 10 wt % to about 20 wt %, or about 12 wt % to about 25 wt %, or about 12 wt % to about 20 wt %, or about 15 wt % to about 25 wt %, or about 15 wt % to about 20 wt %.

In any embodiment, after sulfidation, the sulfided bulk catalyst may include one or more Group VIII metals, such as Ni, and one or more Group VIB metals, such as Mo or W, for example, where the combined amount of Group VIII metal and Group VIB metal is about 30 wt % to about 85 wt % on a metal oxide basis. After sulfidation, at least a portion of the metal in the sulfided bulk catalyst can be in a sulfided form; thus, the amorphous sulfide bulk catalyst may include sulfides of one or more Group VIII and/or Group VIB metals. In particular, without being bound by any particular theory, it is believed that the Group VIB metal can form stacks of sulfided metal believed to have a MeS₂ stoichiometry, where Me represents the Group VIB metal. For example, if Mo is the Group VIB metal, stacks of MoS₂ will be formed. In catalysts formed according to the disclosure, the average stack height of the sulfided Group VIB metal will be from about 1.1 to about 2. In another embodiment, the average stack height will be at least 1.1, or at least 1.2, or at least 1.3, or at least 1.4, or at least 1.5. In still another embodiment, the average stack height will be 2.2 or less, or 2.1 or less, or 2.0 or less, or 1.9 or less. It is noted that each of the above lower bounds for the average stack height is explicitly contemplated in conjunction with each of the upper bounds. Without being bound by any particular theory, it is believed that a lower stack height corresponds indirectly to increased activity.

### Hydroprocessing Methods

The catalyst compositions described herein can be suitable for hydroprocessing hydrocarbon feeds. Examples of hydroprocessing processes include hydrogenation of unsaturates, hydrodesulfurization, hydrodenitrogenation, hydrodearomatization and mild hydrocracking. Preferred are hydrodesulfurization and hydrodenitrogenation. Conventional hydroprocessing conditions include temperatures from about 250° C. to 450° C., hydrogen pressures from about 50 to about 3700 psig or about 200 to about 1200 psig, liquid hourly space velocities from 0.1 to 10 h⁻¹, and hydrogen treat gas rates from about 500 to about 10000 SCF/B or about 500 to about 5000 SCF/B.

Feedstocks suitable for processing using a bulk catalyst as described herein can include petroleum feedstreams boiling in the distillate range. This boiling range can typically be from about 140° C. to about 360° C. and includes middle distillates, and light gas oil streams. Non-limiting examples of preferred distillate streams include diesel boiling range feed, jet fuel and heating oils. Additionally or alternatively, the bulk catalyst described herein can be suitable for processing of feeds including at least a portion of vacuum distillate, such as feeds having a boiling range from about 140° C. to about 500° C. In any embodiment, a feedstock, such as a diesel boiling range feed, can be contacted with a bulk metallic catalyst as described herein in the presence of a treat gas comprising hydrogen (H₂) in at least one reaction zone under sufficient reaction conditions to produce a treated diesel product. The feedstocks can contain a substantial amount of nitrogen, e.g. at least 10 ppmw nitrogen to even greater than 1500 ppmw, for example, about 10 ppmw to about 1500 ppmw or about 300 ppmw to about 1500 ppmw, in the form of organic nitrogen compounds. The feedstocks can also contain a significant sulfur content, such as from about 0.1 wt % to about 3 wt %, or about 1 wt % to about 3 wt %, or higher.

Hydroprocessing can also include slurry and ebullating bed hydrotreating processes for the removal of sulfur and nitrogen compounds, and the hydrogenation of aromatic molecules present in light fossil fuels, such as petroleum mid-distillates, particularly light catalytic cycle cracked oils (LCCO). Distillates derived from petroleum, coal, bitumen, tar sands, or shale oil are likewise suitable feeds. Hydrotreating processes utilizing a slurry of dispersed catalysts in admixture with a hydrocarbon feed are generally known. For example, U.S. Pat. No. 4,557,821 discloses hydrotreating a heavy oil employing a circulating slurry catalyst. Other patents disclosing slurry hydrotreating include U.S. Pat. Nos. 3,297,563, 2,912,375, and 2,700,015. A slurry hydroprocessing process can be used to treat various feeds including mid-distillates from fossil fuels such as light catalytic cycle cracking oils (LCCO).

Hydrogenation conditions include reactions in the temperature range of about 100° C. to about 350° C. and pressures from about five atmospheres (506 kPa) and 300 atmospheres (30,390 kPa) hydrogen, for example, 10 to 275 atmospheres (1,013 kPa to 27,579 kPa). In further embodiments, the temperature may be in the range including 180° C. and 320° C. and the pressure may be in the range including 15,195 kPa and 20,260 kPa hydrogen. The hydrogen to feed volume ratio to the reactor under standard conditions (25° C., 1 atmosphere pressure) can typically range from about is 20-200, or for water-white resins 100-200.

Process conditions applicable for the use of the catalysts described herein may vary widely depending on the feedstock to be treated. Thus, as the boiling point of the feed increases, the severity of the conditions will also increase. The following table (Table 1) serves to illustrate typical conditions for a range of feeds.

TABLE 1
Typical Feed Hydroprocessing Conditions

| | Typical | | | Space | H₂ Gas |
|---|---|---|---|---|---|
| | Boiling Range | | Pressure, | Velocity | Rate |
| Feed | ° C. | Temp ° C. | MPa | V/V/Hr | Nm³/m³ |
| Naphtha | 25-210 | 100-370 | 1-6 | 0.5-10 | 15-350 |
| Diesel | 170-350 | 200-400 | 1.5-10 | 0.5-4 | 85-1000 |
| Heavy | 325-475 | 260-430 | 1.5-17 | 0.3-2 | 150-1000 |
| gas oil | | | | | |
| Lube | 290-550 | 200-450 | 0.5-21 | 0.2-5 | 15-2000 |
| Resid | 10-50% > 575 | 340-450 | 6.5-110 | 0.1-1 | 350-2000 |

The following examples will serve to illustrate, but not limit this invention.

### EXAMPLES

### Example 1A—Catalyst Precursor Synthesis-Catalyst Precursor a (NiMoCSi)

Two solutions (Solution A and Solution B) were prepared before their mixing. Solution A was prepared by dissolving 145.5 g of ammonium heptamolybdate tetrahydrate and 48.6 g of nickel carbonate hydroxide tetrahydrate in 250.3 g of 48.6% gluconic acid aqueous solution. In Solution A, the molar ratio of Mo/Ni was 2. The molar ratio of gluconic acid/(Mo+Ni) was 0.5. Solution B was prepared by dissolving 117.7 g of Dynsylane® HYDROSIL 2627 in 117.7 g of water. The mixture solution (Solution A) of NiMo-gluconic acid was slowly added into the aqueous solution (Solution B) of Dynsylane® HYDROSIL 2627 with vigorous stirring to form a Solution C. Solution C was vacuum-dried at 55° C. for 4 hours, then it was dried at 120° C. for additional 4 hours. After grinding, the black solids were placed in a box furnace. The furnace was ramped from room temperature to 752° F. (400° C.) at rate of 10° F./min in a nitrogen atmosphere with a flow rate of 5 vol/vol cat/min. The samples were held at 752° F. (400° C.) in nitrogen for 4 hrs and Catalyst Precursor A was obtained. The silica content in the sample was targeted at 10 wt % as SiO2. The sample's powdery material was broken up by 20 min grinding with a mortar and a pestle. The particles between 297-88 microns were collected for binding and formulations. The binder used for catalyst formulation was polyethylene glycol (PEG). The amount of the binder used for binding was 10 wt %. The sample was pressed at 30 tons for 10 minutes. Then the sample disc was broken up into particles sieved between 1410-710 microns. The bound particles were calcined in nitrogen at 752° F. (400° C.) for 4 hours to form Bound Catalyst Precursor A. The N₂ flow rate was controlled at 5 volume/volume catalyst/minute.

### Example 1B—Catalyst Precursor Synthesis-Catalyst Precursor B (CoMoCSi)

Catalyst Precursor B was prepared with the similar procedures used as in the preparation of Catalyst Precursor A. Two solutions (Solution A and Solution B) were prepared. Solution A was prepared by dissolving 145.506 g of ammonium heptamolybdate tetrahydrate and 102.972 g of cobalt acetate tetrahydrate in a 250.29 g of 48.6% gluconic acid aqueous solution. In the mixture solution (Solution A), the molar ratio of Mo/Co was kept at 2. The molar ratios of gluconic acid/(Mo+Co) were adjusted to 0.5. Solution B was prepared by dissolving an 117.70 g of Dynsylane® HYDROSIL 2627 in 117.70 g of water. The mixture solution of CoMo-gluconic acid (Solution A) was slowly added into the aqueous solution (Solution B) of Dynsylane® HYDROSIL 2627 with stirring to form Solution C. Solution C was vacuum-dried at 55° C. for 4 hours, then it was kept at 120° C. for additional 4 hours. After grinding, the black solids were placed in a box furnace. The furnace was ramped from room temperature to 752° F. (400° C.) at rate of 10° F./min in the nitrogen flow with 5 vol/vol cat/min flow rate. The samples were held at 752° F. (400° C.) in nitrogen for 4 hrs and Catalyst Precursor B was obtained. The silica content in the sample was targeted at 10 wt % as SiO₂. The sample's powdery material was broken up by 20 min grinding with a mortar and a pestle. The particles between 297-88 microns were collected for binding and formulations. The binder used for catalyst formulation was polyethylene glycol (PEG). The amount of the binder used for binding was 10 wt %. The sample was pressed at 30 tons for 10 minutes. Then the sample disc was broken up into particles sieved between 1410-710 microns. The bound particles were calcined in nitrogen at 752° F. (400° C.) for 4 hours to form Bound Catalyst Precursor B. The N₂ flow rate was controlled at 5 volume/volume catalyst/minute.

### Example 1C—Catalyst Precursor Synthesis-Catalyst Precursor C (NiWSiC)

Two solutions (Solution A and Solution B) were prepared. Solution A was prepared by dissolving 127.365 g of ammonium metatungstate hydrate and 30.3708 g of nickel carbonate hydroxide tetrahydrate in a 234.665 g of 48.6% gluconic acid aqueous solution. In the mixture solution (Solution A), the molar ratio of Ni/W was kept at 0.5. The molar ratios of gluconic acid/(Ni+W) were adjusted to 0.75. Solution B was prepared by dissolving an 129.06 g of Dynsylane® HYDROSIL 2627 in 129.06 g of water. The mixture solution of NiW-gluconic acid (Solution A) was slowly added into the aqueous solution (Solution B) of Dynsylane® HYDROSIL 2627 with stirring to form Solution C. Solution C was vacuum-dried at 55° C. with nitrogen flowing overnight, then it was kept at 120° C. overnight. After grinding, the sponge like black solids were placed in a calciner. The calciner was ramped from room temperature to 752° F. (400° C.) at rate of 10° F./min in the nitrogen flow with 5 vol/vol cat/min flow rate. The samples were held at 752° F. (400° C.) in nitrogen for 4 hrs and Catalyst Precursor C was obtained.

### Example 1D—Catalyst Precursor Synthesis-Catalyst Precursor D (CoNiMoCSi)

A solution was prepared by dissolving 36.3765 g of ammonium heptamolybdate (Aldrich#22,123-6, containing 81.8 wt % MoO3, 29.756 g of MoO₃, MW: 143.94), and 12.8715 g of cobalt acetate tetrahydrate (Co(Ac)₂*4H₂O, Alfa#44344, containing 23.66 wt % Co, 3.0455 g of Co, MW: 58.933, CoO MW: 74.933, 3.872 g of CoO), and 6.0743 g of nickel carbonate hydroxide tetrahydrate (2NiCO₃.3Ni(OH)₂.4H₂O, MW 587.67, NiO MW: 74.71, 3.8611 g of NiO) in 62.5725 g of gluconic acid aqueous solution (48.6%, Aldrich G195-1, 30.41 g. MW: 196.16). The solution was stirred with a magnetic bar until the solution became clear. Into the solution, 29.425 g of Dynsylane® HYDROSIL 2627 2627 (20.0% solid, containing 5.885 g of SiO₂) was added, and the solution was stirred with a magnetic bar until the solution became clear. In the solution, the molar ratio of (Co+Ni)/Mo was 0.5, and the molar ratio of gluconic acid/(Co+Ni+Mo) was 0.5. The solution was vacuum-dried at 55° C. with nitrogen flowing overnight, then it was kept at 120° C. overnight. After grinding, the sponge like black solids were placed in a calciner. The calciner was ramped from room temperature to 752° F. (400° C.) at rate of 10° F./min in the nitrogen flow with 5 vol/vol cat/min flow rate. The samples were held at 752° F. (400° C.) in nitrogen for 4 hrs and Catalyst Precursor D was obtained.

### Example 2-Catalyst Precursor Characterization

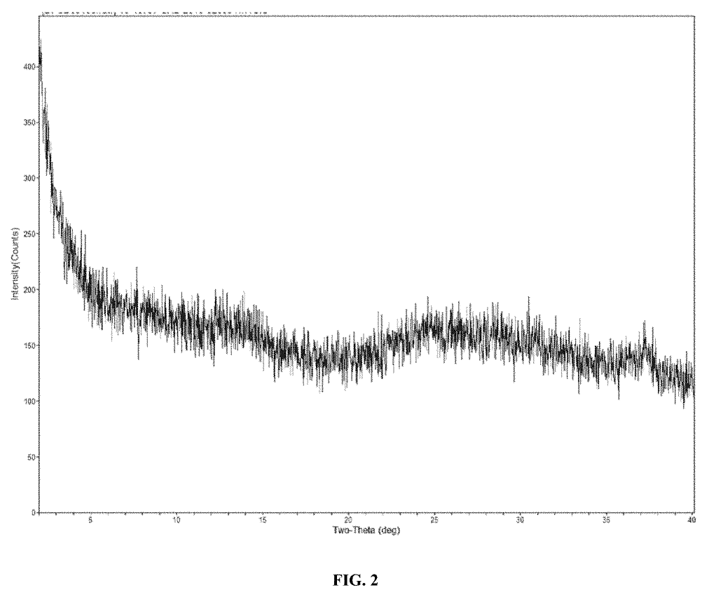

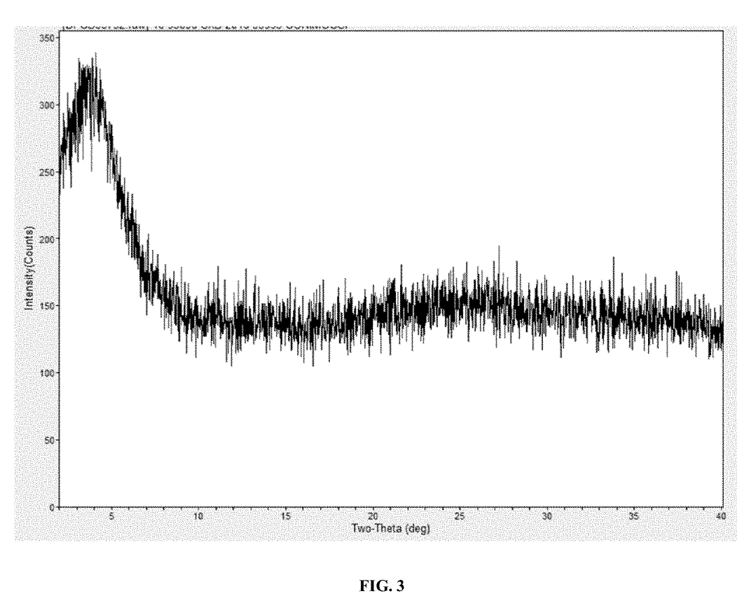

The BET surface area and carbon content, metals content, silicon content, and silica content were measured for Catalyst Precursors A-D. The results are shown in Table 2 below. An X-ray Diffraction (XRD) analysis was performed on Catalyst Precursors A-D as well. The resulting XRD spectrums for Catalyst Precursor A and Catalyst Precursor B are shown in FIG. 1. The XRD spectrum for Catalyst Precursor C is shown in FIG. 2, and the XRD spectrum for Catalyst Precursor D is shown in FIG. 3. As shown in FIGS. 1-3, Catalyst Precursors A-D were amorphous in nature. No crystallized phases were detected. It is believed that the organic compound-based component, i.e., residual carbon incorporated inside catalysts, may interrupt the crystallizations of CoMo, NiMo, NiW, or CoNiMo oxides, or small crystals of CoMo, NiMo, NiW, or CoNiMo oxides are framed in the carbon matrix.

TABLE 2
Catalyst Precursor Characterization

| | | | | SiO₂ (wt %) | |
|---|---|---|---|---|---|
| | BET | C (wt %) | | (calculated | |
| | SA | by | Co, Ni, W, Mo, Si (wt %) by | based on Si | XRD G701 |
| Precursors | (m²/g)* | E1064 | XRF E1003 | content) | test |
| Catalyst | 1.20 | 20.21 | 15.13 Ni, 48.44 Mo, and 3.04 Si | 6.4 | Amorphous |
| Precursor A | | | | | |
| (NiMoCSi) | | | | | |
| Catalyst | 0.33 | 24.80 | 16.15 Co, 47.71 Mo, and 3.10 Si | 6.6 | Amorphous |
| Precursor B | | | | | |
| (CoMoCSi) | | | | | |
| Catalyst | 36.6 | 8.58 | 21.29 Ni, 52.29 W, and 2.8 Si | 6.0 | Amorphous |
| Precursor C | | | | | |
| (NiWSiC) | | | | | |
| Catalyst | 2.2 | 25.4 | 6.824 Ni, 8.005 Co, 48.6 Mo, | 7.1 | Amorphous |
| Precursor D | | | and 3.3 Si | | |
| (CoNiMoCSi) | | | | | |

It can be seen from Table 2 above that Catalyst Precursors A-D had relatively lower surface areas. In particular, Catalyst Precursor B had a surface area less than 1 m²/g. After heating, both Catalyst Precursor A and Catalyst Precursor B contained substantial amounts of carbon of about 8 to 26 wt %. The carbon content of the catalyst precursors is a function of the heating conditions the catalysts experienced, i.e., the time and the temperature of the heating profile, as well as the ratios of gluconic acid to metal(s). The carbon content in the bulk catalyst precursors can influence the morphology of the metals in such precursors and the resulting hydrodesulfurization catalytic activities of the sulfided catalysts.

### Example 3—Catalyst Properties and Activity for Diesel Hydrodesulfurization

Catalysts based on the precursors described above were tested for diesel hydrodesulfurization and hydrodenitrogenation activity using TPR (Three Phase Reactor) units. The TPR units were continuous flow, fixed-bed reactors, which have 8 reactors immersed in a sand bath. A syringe pump delivered steady flow of diesel feed into the reactors. A flow meter controlled the flow of H₂ treat gas. During the hydrotreatment test runs, liquid feed was mixed with H₂ treat gas and flowed through the catalyst bed in an up-flow mode. The reactor pressure was controlled by a pressure regulator. The liquid and gas products from the reactors were separated by product accumulators. Liquid products were collected in the bottom of the accumulators while gas products exited through the top of the accumulators. A pressure regulator controlled the backend pressure. Product liquid was stripped in a fume hood with N₂ for 1 hour to remove dissolved H₂S.

The S and N concentrations in the products were analyzed. 1.5 order kinetics were used to calculate HDS rate constants, assuming that reactivity of S compounds in the feed was a function of continuous distribution of S species. The 1.5 order kinetic model has limitations when S concentrations in the feed are low. HDN rate constants were calculated as 1st order, assuming that reactivity of all N species in the feed are equivalent. The kinetic equations used for calculations were:

kHDS=LHSV*(1/√S_{product}−1/√S_{feed})*C (1.5 order), C=100 was used as the constant for this calculation

kHDN=LHSV*ln(N_{feed}/N_{product}) (1st order)

During the tests, 1 cc of the catalyst with particle sizes between 90 and 300 microns was charged in the reactor. Note that although a volume of catalyst is specified, the volume was determined based on a catalyst weight. The catalyst was sandwiched between two layers of inert material of silicon carbide inside a U-type reactor. The weights and volumes of the catalysts were reordered to calculate the kinetic constants. All the diesel HDS catalysts (see Table 3) were sulfided using a diesel feed that was spiked with an additional 2.3 wt % of sulfur in the form of DMDS. The catalysts were sulfide using the spiked diesel feed at 450° F. for 20 hrs with 450 psig H₂ pressure, and another 20 hrs at 610° F. The total S in the spiked diesel feed was 2.5 wt %, based on a 0.2 wt % sulfur content originally present in the feed and the 2.3 wt % of sulfur added by spiking with DMDS. The bulk catalysts shown in Table 3 correspond to catalysts made from Catalyst Precursor A and Catalyst Precursor B. The bulk catalysts are therefore referred to as Catalyst A and Catalyst B. Reference 1 refers to Haldor Topsoe TK-609 catalyst and Reference 2 refers to Albermarle KF-757 catalyst. Table 3 also shows the loading volume and corresponding weight for a commercially available supported CoMo catalyst that was used as a reference catalyst.

TABLE 3
Catalysts Loaded in TPR unit

| Catalyst | Volume, cm³ | Weight, g |
|---|---|---|
| Reference 1 | 1.0 | 0.888 |
| Catalyst A | 1.0 | 0.928 |
| Catalyst B | 1.0 | 0.877 |
| Reference 2 | 1.0 | 0.841 |

The catalyst evaluation conditions were an LHSV=1 hr⁻¹, about 220 or about 650 psig H₂ pressure, a temperature of about 321° C. (610° F.) to about 338° C. (640° F.), and a treat gas rate of about 1000 or 2000 SCF/B H₂. Two diesel feeds, LGO and a CHD-LCO blend, were used for catalyst evaluations. LGO contains 2010 ppm S and 62.8 ppm N with API gravity of 35.05, and T95 of 680.8° F. The LGO feed contains 25.1 wt % aromatics with 0.9% of three ring aromatics. The CHD-LCO blend contains 1.37 wt % S and 317 ppm N with API gravity of 28.48, and T95 of 702.1° F. The CHD-LCO blend feed contains 37.29 wt % aromatics with 7.21% of three ring aromatics.

FIG. 4 shows the volumetric HDS activities for Catalyst B relative to catalyst Reference 2 (dashed horizontal line). At 220 psi pressure, 640° F., LHSV of 1, and 1000 SCF/B (100% H₂) treat gas rate, the sulfur numbers of the hydrocarbon products are between 10 and 100 ppm by Antek analyses. The HDS activity for Catalyst B was about 125% as that of Reference 2 on LGO feed. At 650 psi H₂ pressure, and 610° F. temperature, the HDS activity for Catalyst B was increased to ˜270%, compared to Reference 2 on LGO feed. At 650 psi pressure, 660° F., LHSV of 1, with 2000 SCF/B treat gas rate (80% H₂/20% CH4, 520 psig PH2), the HDS activity for Catalyst B was ˜225% as compared to Reference 2 on CHD-LCO feed. After 55 days on oil (also referred to as “end of run” or “EOR”), HDS activity for Catalyst B was rechecked at the start of run conditions, Catalyst B still had the same HDS activity as the initial activity, ˜125% as that of reference catalyst Reference 2 on LGO feed.

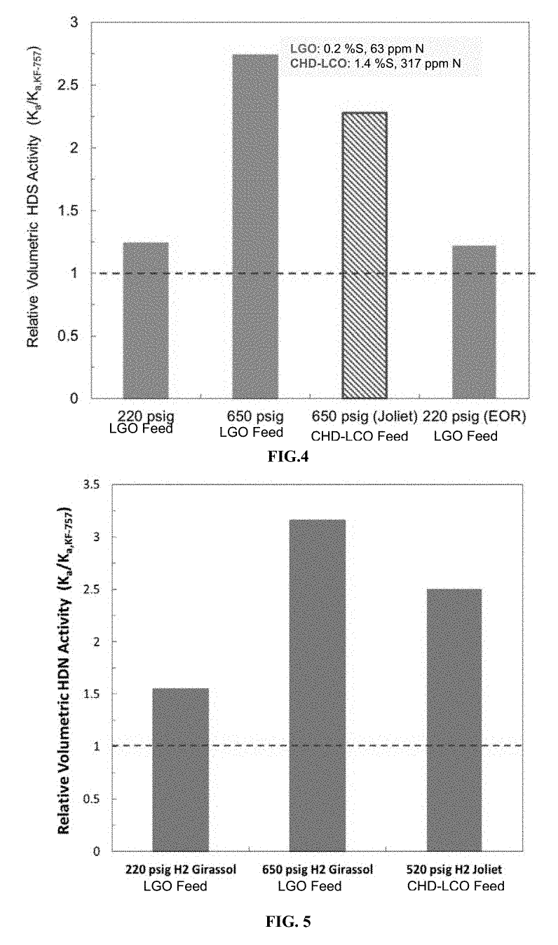

FIG. 5 shows the volumetric HDN activities of Catalyst B relative to catalyst Reference 2 (dashed horizontal line). At 220 psi H₂ pressure, the HDN activity of Catalyst B was about 155% as that of Reference 2 on LGO feed. When H₂ pressure was increased to 650 psi, the HDN activity of Catalyst B was increased to 320% as that of Reference 2 on LGO feed. At 520 psi H₂ partial pressure, the HDN activity of Catalyst B was about 250% compared to Reference 2 on CHD-LCO. Heavier CHD-LCO feed has 317 ppm N. Light LGO feed has 62.8 ppm N. Both HDS and HDN RVAs of Catalyst B/Reference 2 are not sensitive to the feed change from LGO feed to CHD-LCO feed.

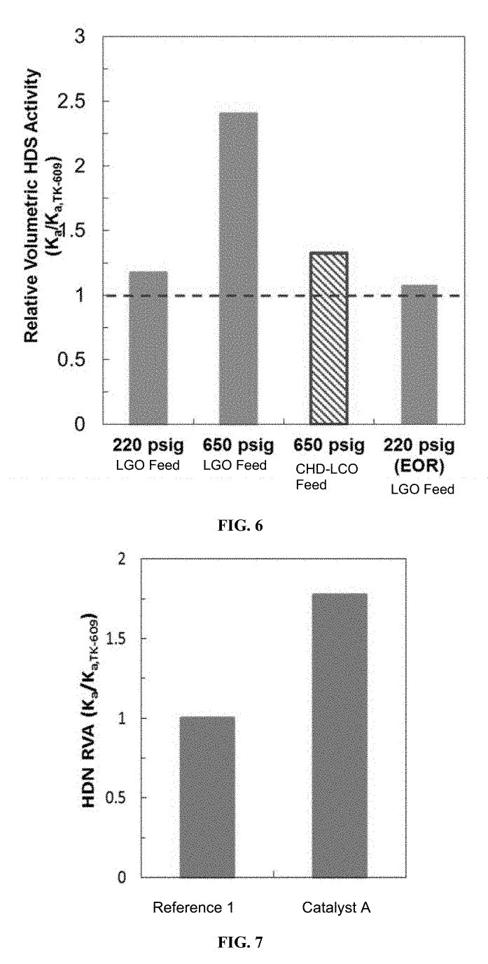

FIG. 6 shows the relative volumetric HDS activities for Catalyst A relative to catalyst Reference 1 (dashed horizontal line). Similar catalytic performance was observed for Catalyst A. At 220 psi pressure, HDS activity for Catalyst A was 120% as that of Reference 1 on LGO feed. At 650 psi H₂, its HDS activity was ˜240% for Catalyst A compared to Reference 1. At 650 psi pressure, 660° F., LHSV of 1, with 2000 SCF/B treat gas rate (80% H_{2/20}% CH4, 520 psig PH2), HDS activity for Catalyst A was ˜130% as that of Reference 1 on CHD-LCO feed. After 55 days on oil, HDS activity for Catalyst A was 110% as that of Reference 1 on LGO feed, which was less than the initial HDS activity, 120% of Reference 1's HDS activity.

FIG. 7 shows the volumetric HDN activities of Catalyst A relative to catalyst Reference 1. At 520 psi H₂ partial pressure, the HDN activity of the bulk catalyst NiMoCSi was about 175% as to TK-609 on CHD-LCO.

### Additional Embodiments

Additionally or alternatively, the present invention can include one or more of the following embodiments.

### Embodiment 1

A bulk metallic catalyst precursor comprising: a) Ni; b) Mo or W, wherein a combined amount of Ni and Mo or a combined amount of Ni or W is about 30 wt % to about 85 wt % on a metal oxide basis; c) about 10 wt % to about 60 wt % of an organic compound-based component, wherein the organic compound-based component is based on at least one organic complexing agent; and d) about 1 wt % to about 50 wt % of an organo-metalloxane polymer, an organo-metalloxane gel, or a combination thereof, preferably, at least about 5 wt %, wherein the organo-metalloxane polymer is selected from the group consisting of an organo-siloxane polymer, an organo-alumoxane polymer, an organo-titanoxane polymer, and a combination thereof, optionally, wherein the bulk metallic catalyst precursor has a BET surface area of 50 m²/g or less.

### Embodiment 2

The bulk metallic catalyst precursor of Embodiment 1 or 2, wherein the organic compound-based component is further based on organic functional groups from the organo-metalloxane polymer, organo-metalloxane gel, or combination.

### Embodiment 3

The bulk metallic catalyst precursor of Embodiment 1 or 2, wherein the organo-metalloxane polymer, organo-metalloxane gel, or combination thereof is water soluble.

### Embodiment 4

The bulk metallic catalyst precursor of any one of the previous embodiments, wherein the organo-metalloxane polymer comprises an organo-siloxane polymer, and wherein at least a portion of the organic functional groups of the organo-siloxane polymer comprise amines and/or wherein the organo-metalloxane polymer, organo-metalloxane gel, or combination thereof comprises an organo-alumoxane polymer, organo-alumoxane gel, or combination thereof, and wherein at least a portion of the organic functional groups of the organo-alumoxane polymer, organo-alumoxane gel, or combination thereof comprise carboxylates.

### Embodiment 5

The bulk metallic catalyst precursor of any one of the previous embodiments, wherein the catalyst precursor has one or more of the following: i) a C content of about 5 wt % to about 30 wt %, ii) a Si content of about 1 wt % to about 10 wt %, and iii) a SiO₂ content of about 2 wt % to about 30 wt %.

### Embodiment 6

The bulk metallic catalyst precursor of any one of the previous embodiments, wherein the catalyst precursor further comprises Co, and wherein a combined amount of Ni, Mo and Co or a combined amount of Ni, W and Co is about 30 wt % to about 85 wt % on a metal oxide basis.

### Embodiment 7

The bulk metallic catalyst precursor of any one of the previous embodiments, wherein the catalyst precursor further comprises a transition metal and/or the catalyst precursor further comprises a binder, and the binder comprises a silica polymer, polyethylene glycol, or a combination thereof.

### Embodiment 8

An amorphous sulfided bulk metallic catalyst comprising: a) Ni; b) Mo or W, wherein a combined amount of Ni and Mo or a combined amount of Ni or W is about 30 wt % to about 85 wt % on a metal oxide basis; c) sulfides of one or more of: Ni, Mo, W, NiMo and NiW; d) about 10 wt % to about 60 wt % of an organic compound-based component, the organic compound-based component is based on at least one organic complexing agent; and e) about 1 wt % to about 50 wt % of an organo-metalloxane polymer, an organo-metalloxane gel, or a combination thereof, wherein the organo-metalloxane polymer is selected from the group consisting of an organo-siloxane polymer, an organo-alumoxane polymer, an organo-titanoxane polymer, and a combination thereof, optionally, wherein the amorphous sulfided bulk metallic catalyst precursor has a BET surface area of 50 m²/g or less.

### Embodiment 9

The amorphous sulfided bulk metallic catalyst of Embodiment 8, further comprising Co.

### Embodiment 10

A method of preparing a bulk metallic catalyst precursor comprising: mixing a first aqueous solution with a second solution to form an intermediate solution; drying and calcining the intermediate solution to form the bulk metallic catalyst precursor according to any one of Embodiments 1 to 7, wherein the first aqueous solution comprises: (i) a Ni-containing precursor and a Mo-containing precursor, or a Ni-containing precursor and a W-containing precursor; and (ii) at least one organic complexing agent, wherein the molar ratio, as a fractional value, of Mo to Ni or W to Ni is about 0.1 to about 10, and the molar ratio, as a fractional value, of organic complexing agent to Ni and Mo or organic complexing agent to Ni and W is about 0.1 to about 10; and wherein the second solution comprises at least one organo-metalloxane polymer, an organo-metalloxane gel, or a combination thereof, wherein the organo-metalloxane polymer is selected from the group consisting of an organo-siloxane polymer, an organo-alumoxane polymer, an organo-titanoxane polymer, and a combination thereof.

### Embodiment 11

The method of Embodiment 10, wherein the at least one organic complexing agent is an organic acid, for example, selected from the group consisting of glyoxic acid, gluconic acid, oxalecetic acid and a combination thereof.

### Embodiment 12

The method of Embodiment 10 or 11, wherein the organo-metalloxane polymer comprises an organo-siloxane polymer, and wherein at least a portion of the organic functional groups of the organo-siloxane polymer comprise amines and/or wherein the organo-metalloxane polymer, organo-metalloxane gel, or combination thereof comprises an organo-alumoxane polymer, organo-alumoxane gel, or combination thereof, and wherein at least a portion of the organic functional groups of the organo-alumoxane polymer, organo-alumoxane gel, or combination thereof comprise carboxylates.

### Embodiment 13

The method of any one of Embodiments 10 to 12, wherein the first aqueous solution further comprises a Co-containing precursor.

### Embodiment 14

The method of any one of Embodiments 10 to 13, further comprising contacting the bulk metallic catalyst precursor with a sulfur-containing compound at a temperature of about 350° C. or less to form an amorphous sulfided bulk metallic catalyst.

### Embodiment 15

A method for hydroprocessing a diesel boiling range feed, wherein the method comprises: contacting the diesel boiling range feed with a bulk metallic catalyst in the presence of a treat gas comprising hydrogen (H₂) in at least one reaction zone under sufficient reaction conditions to produce a treated diesel product, wherein the diesel boiling range feed comprises a sulfur content of about 1 wt % to about 3 wt % and/or a nitrogen content of about 300 ppmw to about 1500 ppmw, wherein the bulk metallic catalyst comprises: a) Ni; b) Mo or W, wherein a combined amount of Ni and Mo or a combined amount of Ni or W is about 30 wt % to about 85 wt % on a metal oxide basis; c) sulfides of one or more of: Ni, Mo, W, NiMo and NiW; d) about 10 wt % to about 60 wt % of an organic compound-based component, wherein the organic compound-based component is based on at least one organic complexing agent; and e) about 1 wt % to about 50 wt % of an organo-metalloxane polymer, an organo-metalloxane gel, or a combination thereof, wherein the organo-metalloxane polymer is selected from the group consisting of an organo-siloxane polymer, an organo-alumoxane polymer, an organo-titanoxane polymer, and a combination thereof, optionally, wherein the bulk metallic catalyst has a BET surface area of 50 m²/g or less.

### Embodiment 16

A method for hydroprocessing a diesel boiling range feed, wherein the method comprises: contacting the diesel boiling range feed with a bulk metallic catalyst in the presence of a treat gas comprising hydrogen (H₂) in at least one reaction zone under sufficient reaction conditions to produce a treated diesel product, wherein the diesel boiling range feed comprises a sulfur content of about 1 wt % to about 3 wt % and/or a nitrogen content of about 300 ppmw to about 1500 ppmw, wherein the bulk metallic catalyst comprises: a) a Group VIII metal; b) a Group VIB metal, wherein a combined amount of Group VIII metal and Group VIB metal is about 30 wt % to about 85 wt % on a metal oxide basis; c) sulfides of one or more of Group VIII metal and Group VIB metal; d) about 10 wt % to about 60 wt % of an organic compound-based component, wherein the organic compound-based component is based on at least one organic complexing agent; and e) about 1 wt % to about 50 wt % of an organo-metalloxane polymer, an organo-metalloxane gel, or a combination thereof, wherein the organo-metalloxane polymer is selected from the group consisting of an organo-siloxane polymer, an organo-alumoxane polymer, an organo-titanoxane polymer, and a combination thereof, optionally, wherein the bulk metallic catalyst has a BET surface area of 50 m²/g or less.

### Embodiment 17

The method of Embodiment 15 or 16, wherein the reaction conditions comprise a temperature of about 250° C. to about 450° C., a hydrogen pressure of about 200 psig to about 1200 psig and a treat gas rate of about 500 SCF/B to about 5000 SCF/B.

### Embodiment 18

The method of any one of Embodiments 15 to 17, wherein the hydroprocessing comprises hydrodesulfurization and/or hydrodenitrogenation.

### Embodiment 19

The method of any one of Embodiments 15 to 17, wherein the bulk metallic catalyst further comprises Co and sulfides of Co.

Although the present invention has been described in terms of specific embodiments, it is not so limited. Suitable alterations/modifications for operation under specific conditions should be apparent to those skilled in the art. It is therefore intended that the following claims be interpreted as covering all such alterations/modifications as fall within the true spirit/scope of the invention.

1. A bulk metallic catalyst precursor comprising:
a) Ni;
b) Mo or W, wherein a combined amount of Ni and Mo or a combined amount of Ni or W is about 30 wt % to about 85 wt % on a metal oxide basis;
c) about 10 wt % to about 60 wt % of an organic compound-based component, wherein the organic compound-based component is based on at least one organic complexing agent; and
d) about 1 wt % to about 50 wt % of an organo-metalloxane polymer, an organo-metalloxane gel, or a combination thereof, wherein the organo-metalloxane polymer is selected from the group consisting of an organo-siloxane polymer, an organo-alumoxane polymer, an organo-titanoxane polymer, and a combination thereof.

2. The bulk metallic catalyst precursor of claim 1, wherein the catalyst precursor has a BET surface area of 50 m²/g or less.

3. The bulk metallic catalyst precursor of claim 1, wherein the catalyst precursor comprises at least about 5 wt % of the organo-metalloxane polymer, organo-metalloxane gel, or combination thereof.

4. The bulk metallic catalyst precursor of claim 1, wherein the organic compound-based component is further based on organic functional groups from the organo-metalloxane polymer, organo-metalloxane gel, or combination thereof.

5. The bulk metallic catalyst precursor of claim 1, wherein the organo-metalloxane polymer, organo-metalloxane gel, or combination thereof is water soluble.

6. The bulk metallic precursor of claim 1, wherein the organo-metalloxane polymer comprises an organo-siloxane polymer, and wherein at least a portion of the organic functional groups of the organo-siloxane polymer comprise amines.

7. The bulk metallic catalyst precursor of claim 1, wherein the organo-metalloxane polymer, organo-metalloxane gel, or combination thereof comprises an organo-alumoxane polymer, organo-alumoxane gel, or combination thereof, and wherein at least a portion of the organic functional groups of the organo-alumoxane polymer, organo-alumoxane gel, or combination thereof comprise carboxylates.

8. The bulk metallic catalyst precursor of claim 1, wherein the catalyst precursor has one or more of the following:
i) a C content of about 5 wt % to about 30 wt %,
ii) a Si content of about 1 wt % to about 10 wt %, and
iii) a SiO₂ content of about 2 wt % to about 30 wt %.

9. The bulk metallic catalyst precursor of claim 1, wherein the catalyst precursor further comprises Co, and wherein a combined amount of Ni, Mo and Co or a combined amount of Ni, W and Co is about 30 wt % to about 85 wt % on a metal oxide basis.

10. The bulk metallic catalyst precursor of claim 1, wherein the catalyst precursor further comprises an additional transition metal.

11. The bulk metallic catalyst precursor of claim 1, wherein the catalyst precursor further comprises a binder, and the binder comprises a silica polymer, polyethylene glycol, or a combination thereof.

12. An amorphous sulfided bulk metallic catalyst comprising:
a) Ni;
b) Mo or W, wherein a combined amount of Ni and Mo or a combined amount of Ni or W is about 30 wt % to about 85 wt % on a metal oxide basis;
c) sulfides of one or more of: Ni, Mo, W, NiMo and NiW;
d) about 10 wt % to about 60 wt % of an organic compound-based component, the organic compound-based component is based on at least one organic complexing agent; and
e) about 1 wt % to about 50 wt % of an organo-metalloxane polymer, an organo-metalloxane gel, or a combination thereof, wherein the organo-metalloxane polymer is selected from the group consisting of an organo-siloxane polymer, an organo-alumoxane polymer, an organo-titanoxane polymer, and a combination thereof.

13. The amorphous sulfided bulk metallic catalyst of claim 12, wherein the amorphous sulfided bulk metallic catalyst has a BET surface area of 50 m²/g or less.

14. The amorphous sulfided bulk metallic catalyst of claim 12, further comprising Co.

15. A method of preparing a bulk metallic catalyst precursor comprising:
mixing a first aqueous solution with a second solution to form an intermediate solution;
drying and calcining the intermediate solution to form the bulk metallic catalyst precursor;
wherein the first aqueous solution comprises: (i) a Ni-containing precursor and a Mo-containing precursor, or a Ni-containing precursor and a W-containing precursor; and (ii) at least one organic complexing agent, wherein the molar ratio, as a fractional value, of Mo to Ni or W to Ni is about 0.1 to about 10, and the molar ratio, as a fractional value, of organic complexing agent to Ni and Mo or organic complexing agent to Ni and W is about 0.1 to about 10; and
wherein the second solution comprises at least one organo-metalloxane polymer, an organo-metalloxane gel, or a combination thereof, wherein the organo-metalloxane polymer is selected from the group consisting of an organo-siloxane polymer, an organo-alumoxane polymer, an organo-titanoxane polymer, and a combination thereof.

16. The method of claim 15, wherein the at least one organic complexing agent is an organic acid.

17. The method of claim 16, wherein the organic acid is selected from the group consisting of glyoxylic acid, gluconic acid, oxalecetic acid and a combination thereof.

18. The method of claim 15, wherein the organo-metalloxane polymer comprises an organo-siloxane polymer, and wherein at least a portion of the organic functional groups of the organo-siloxane polymer comprise amines.

19. The method of claim 15, wherein the organo-metalloxane polymer, organo-metalloxane gel, or combination thereof comprises an organo-alumoxane polymer, organo-alumoxane gel, or combination thereof, and wherein at least a portion of the organic functional groups of the organo-alumoxane polymer, organo-alumoxane gel, or combination thereof comprise carboxylates.

20. The method of claim 15, wherein the first aqueous solution further comprises a Co-containing precursor.

21. The method of claim 15, wherein the bulk metallic catalyst precursor comprises:
a) a combined amount of Ni and Mo or a combined amount of Ni or W of about 30 wt % to about 85 wt % on a metal oxide basis;
b) about 10 wt % to about 60 wt % of an organic compound-based component, wherein the organic compound-based component is based on the at least one organic complexing agent; and
c) about 1 wt % to about 50 wt % of the organo-metalloxane polymer, organo-metalloxane gel, or combination thereof.

22. The method of claim 21, wherein the bulk metallic catalyst precursor has a BET surface area of 50 m²/g or less.

23. The method of claim 15, further comprising contacting the bulk metallic catalyst precursor with a sulfur-containing compound at a temperature of about 350° C. or less to form an amorphous sulfided bulk metallic catalyst.

24. A method for hydroprocessing a diesel boiling range feed, wherein the method comprises:
contacting the diesel boiling range feed with a bulk metallic catalyst in the presence of a treat gas comprising hydrogen (H₂) in at least one reaction zone under sufficient reaction conditions to produce a treated diesel product,
wherein the diesel boiling range feed comprises a sulfur content of about 1 wt % to about 3 wt % and/or a nitrogen content of about 300 ppmw to about 1500 ppmw,
wherein the bulk metallic catalyst comprises:
a) Ni;
b) Mo or W, wherein a combined amount of Ni and Mo or a combined amount of Ni or W is about 30 wt % to about 85 wt % on a metal oxide basis;
c) sulfides of one or more of: Ni, Mo, W, NiMo and NiW;
d) about 10 wt % to about 60 wt % of an organic compound-based component, wherein the organic compound-based component is based on at least one organic complexing agent; and
e) about 1 wt % to about 50 wt % of an organo-metalloxane polymer, an organo-metalloxane gel, or a combination thereof, wherein the organo-metalloxane polymer is selected from the group consisting of an organo-siloxane polymer, an organo-alumoxane polymer, an organo-titanoxane polymer, and a combination thereof.

25. The method of claim 24, wherein the reaction conditions comprise a temperature of about 250° C. to about 450° C., a hydrogen pressure of about 200 psig to about 1200 psig and a treat gas rate of about 500 SCF/B to about 5000 SCF/B.

26. The method of claim 24, wherein the hydroprocessing comprises hydrodesulfurization and/or hydrodenitrogenation.

27. The method of claim 24, wherein the bulk metallic catalyst has a BET surface area of 50 m²/g or less.

28. The method of claim 24, wherein the bulk metallic catalyst further comprises Co and sulfides of Co.

29. A method for hydroprocessing a diesel boiling range feed, wherein the method comprises:
contacting the diesel boiling range feed with a bulk metallic catalyst in the presence of a treat gas comprising hydrogen (H₂) in at least one reaction zone under sufficient reaction conditions to produce a treated diesel product,
wherein the diesel boiling range feed comprises a sulfur content of about 1 wt % to about 3 wt % and/or a nitrogen content of about 300 ppmw to about 1500 ppmw,
wherein the bulk metallic catalyst comprises:
a) a Group VIII metal;
b) a Group VIB metal, wherein a combined amount of Group VIII metal and Group VIB metal is about 30 wt % to about 85 wt % on a metal oxide basis;
c) sulfides of one or more of Group VIII metal and Group VIB metal;
d) about 10 wt % to about 60 wt % of an organic compound-based component, wherein the organic compound-based component is based on at least one organic complexing agent; and
e) about 1 wt % to about 50 wt % of an organo-metalloxane polymer, an organo-metalloxane gel, or a combination thereof, wherein the organo-metalloxane polymer is selected from the group consisting of an organo-siloxane polymer, an organo-alumoxane polymer, an organo-titanoxane polymer, and a combination thereof.
